(19) United States
(12) Patent Application Publication
(10) Pub. No.: US 2026/0056528 A1
(43) Pub. Date: Feb. 26, 2026

(54) SYSTEMS FOR AND METHODS OF PROVIDING LOW LATENCY COMMUNICATIONS DURING ACTIVE CONTROL

(71) Applicant: Tyco Fire & Security GmbH, Neuhausen am Rheinfall (CH)

(72) Inventors: Matthew J. Asmus, Watertown, WI (US); Daniel F. Leising, New Berlin, WI (US); Gary W. Gavin, Franklin, WI (US); Kaleb Luedtke, West Bend, WI (US)

(73) Assignee: Tyco Fire & Security GmbH, Neuhausen am Rheinfall (CH)

(21) Appl. No.: 18/821,961

(22) Filed: Aug. 30, 2024

Related U.S. Application Data
(60) Provisional application No. 63/686,553, filed on Aug. 23, 2024.

(51) Int. Cl. G05B 19/042

(52) U.S. Cl. CPC G05B 19/0423; G05B 2219/25011

(57) ABSTRACT

A building controller for providing low latency control. The controller recognizes a control algorithm entering an active control mode. In response, the controller enters a deterministic communications mode to send and/or receive priority communications. The communications may come from a sensor used to monitor a building condition or be sent to an actuator used to control the building condition. The prioritized communications are used in order to provide timely and stable control to building equipment.

### CROSS-REFERENCE TO RELATED APPLICATION

This application claims priority to U.S. Provisional Patent Application 63/686,553, filed on Aug. 23, 2024, the entirety of which is incorporated by reference herein.

### BACKGROUND

The present disclosure relates generally to building management systems. The present disclosure relates more particularly to providing low latency communications for active control processes across a building management system.

A building management system (BMS) is, in general, a system of devices configured to control, monitor, and manage equipment in or around a building or building area. A BMS can include a heating, ventilation, or air conditioning (HVAC) system, a security system, a lighting system, a fire alerting system, another system that is capable of managing building functions or devices, or any combination thereof. BMS devices may be installed in any environment (e.g., an indoor area or an outdoor area), and the environment may include any number of buildings, spaces, zones, rooms, or areas. A BMS may include METASYS® building controllers or other devices sold by Johnson Controls, Inc., as well as building devices and components from other sources.

A BMS may include one or more computer systems (e.g., servers, BMS controllers, etc.) that serve as enterprise level controllers, application or data servers, head nodes, master controllers, or field controllers for the BMS. Such computer systems may communicate with multiple downstream building systems or subsystems (e.g., an HVAC system, a security system, etc.) according to like or disparate protocols (e.g., LON, BACnet, etc.). The computer systems may also provide one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with the BMS, its subsystems, and devices.

Network traffic required for viewing or otherwise interacting with the BMS often competes with network traffic required for performing control actions. Controlling certain processes requires communication between the controller, sensors, and actuators at frequent and regular intervals without latency. Control intervals may be 100 ms or less, whereas communications used only for display purposes are not required to be received at regular intervals, and in several applications may be delayed by a minute or more without affecting the operator's ability to monitor the environment. The present disclosure recognizes that a controller of the BMS is actively controlling a building condition and advantageously enters a deterministic communication mode. The deterministic communications mode may prioritize one or more communications from the controller to ensure timely completion of the control action.

### SUMMARY OF THE INVENTION

An embodiment of the present disclosure relates to a building controller for providing low latency control. The building controller includes one or more memory devices having instructions stored thereon that, when executed by one or more processors, cause the one or more processors to perform operations. The operations include entering a deterministic communications mode in response to a control algorithm entering an active control state. The operations also include providing a prioritized communication related to the control algorithm to a building device. The operations also include affecting operations of equipment using the prioritized communication or a response to the prioritized communication.

In some embodiments, the building controller provides communications over at least one of a token passing network, an internet protocol network, or a network using polled communication.

In some embodiments, the operations also include causing the control algorithm to enter the active control state based on a schedule.

In some embodiments, providing the prioritized communication related to the control algorithm includes adjusting a change-of-value configuration on a second building device.

In some embodiments, the building controller provides communications over a network using a token passing protocol, and the operations also include keeping a communications token until the control algorithm exits the active control state.

In some embodiments, the building controller provides communications over a network using a token passing protocol and the operations also include calculating a maximum time a second building controller on the network can hold a communications token given a target latency guarantee.

In some embodiments, the building controller provides communications over an internet protocol network and the operations also include adding a priority to a data header.

In some embodiments, providing the prioritized communication related to the control algorithm includes polling a value required to execute the control algorithm from the building device.

In some embodiments, providing the prioritized communication related to the control algorithm includes communicating a control output to the building device. The building device is connected to an actuator required to perform a control action.

In some embodiments, the operations also include causing a second building device to enter the deterministic communications mode.

In some embodiments, the operations also include determining a next building controller that should enter the deterministic communications mode.

An embodiment of the present disclosure relates to a building controller for providing low latency control. The building controller includes one or more memory devices having instructions stored thereon that, when executed by one or more processors, cause the one or more processors to perform operations. The operations include entering a deterministic communications mode. The deterministic communications mode is characterized by providing lower latency communications to or from the building controller. The operations also include sending a first indication indicating that the building controller has entered the deterministic communications mode. The operations also include receiving a second indication from a second building controller, the second indication indicating that the second building controller has entered the deterministic communications mode. The operations also include adjusting characteristics related to how the building controller communicates in response to the second indication.

In some embodiments, the building controller provides communications over at least one of a token passing network, an internet protocol network, or a network using polled communication.

In some embodiments, the operations also include predicting a communications load on a network, and entering the deterministic communications mode is performed in response to the predicted communications load being greater than a threshold.

In some embodiments, the building controller provides communications over an internet protocol network and the operations further comprise adding a priority to a data header.

In some embodiments, the operations also include communicating a control output to a building device connected to an actuator required to perform a control action.

In some embodiments, the operations also include sending a third indication indicating a next building controller to enter the deterministic communications mode.

An embodiment of the present disclosure relates to a method for providing low latency control. The method includes generating a determination whether a control algorithm will violate requirements related to timing requirements of receiving sensor measurements or providing control commands required for the control algorithm. The method also includes entering a deterministic communications mode based on the determination. The method also includes adjusting a change-of-value subscription for a period of time of the deterministic communications mode. The method also includes operating equipment based on the control algorithm.

In some embodiments, the method also includes determining a next controller that should enter the deterministic communications mode.

In some embodiments, the method also includes communicating a control output to another building device connected to an actuator required to perform a control action.

This summary is illustrative only and should not be regarded as limiting.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a building management system (BMS), according to some embodiments.

FIG. 2 is a block diagram of a BMS that serves the building of FIG. 1, according to some embodiments.

FIG. 3 is a block diagram of a BMS controller that can be used in the BMS of FIG. 2, according to some embodiments.

FIG. 4 is another block diagram of the BMS that serves the building of FIG. 1, according to some embodiments.

FIG. 5A is an illustrative diagram of an air handling unit with various devices configured to control conditions of the air handling unit, according to some embodiments.

FIG. 5B is a state transition diagram for an example finite state machine, according to some embodiments.

FIG. 6 is an illustrative diagram of a variable air volume system with devices configured to control the system and other equipment controlled by equipment on the same network, according to some embodiments.

FIG. 7 is a block diagram of a building controller with a deterministic communications mode and other devices on the network, according to some embodiments.

FIG. 8 is a flow of operations for controlling equipment using prioritized communications, according to some embodiments.

FIG. 9 is a flow of operations for adjusting communications characteristics, according to some embodiments.

FIG. 10 is another flow of operations for controlling equipment using prioritized communications, according to some embodiments.

FIG. 11 is a flow of operations for prioritizing communication on a network implementing a token passing protocol, according to some embodiments.

FIG. 12 is another flow of operations for prioritizing communication on a network implementing a token passing protocol, according to some embodiments.

FIG. 13 is a flow of operations for adjusting a change-of-value subscription based on a determination that a control algorithm will violate timing requirements, according to some embodiments.

### DETAILED DESCRIPTION

### Overview

Referring generally to the FIGURES, various systems for and methods of providing low latency communications for control are shown. Control may be provided using state machines wherein some states (e.g., modes) actively control a building condition by adjusting an actuator. Control may be provided by a building controller connected to various sensors and actuators over a network. To ensure that control is timely provided, the building controller may enter a deterministic communications mode. Communication related to active control may be prioritized. Operations for entering a deterministic mode and/or providing prioritized communications, as well as the advantages of such communications, are described in more detail herein.

### Building and Building Management System

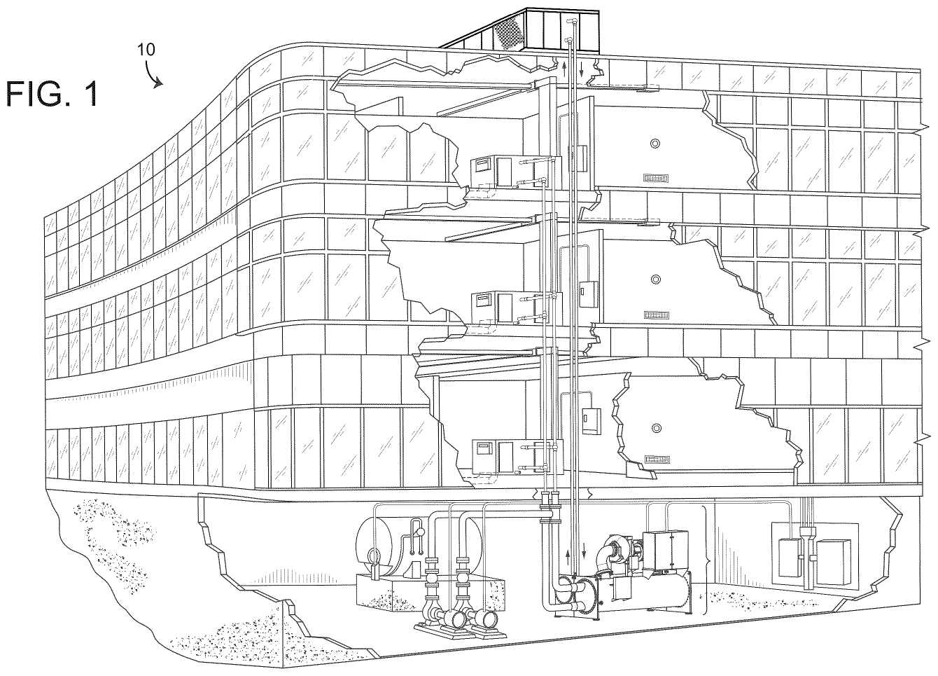

Referring now to FIG. 1, a perspective view of a building 10 is shown, according to an exemplary embodiment. A BMS serves building 10. The BMS for building 10 may include any number or type of devices that serve building 10. For example, each floor may include one or more security devices, video surveillance cameras, fire detectors, smoke detectors, lighting systems, HVAC systems, or other building systems or devices. In modern BMSs, BMS devices can exist on different networks within the building (e.g., one or more wireless networks, one or more wired networks, etc.) and yet serve the same building space or control loop. For example, BMS devices may be connected to different communications networks or field controllers even if the devices serve the same area (e.g., floor, conference room, building zone, tenant area, etc.) or purpose (e.g., security, ventilation, cooling, heating, etc.).

BMS devices may collectively or individually be referred to as building equipment. Building equipment may include any number or type of BMS devices within or around building 10. For example, building equipment may include controllers, chillers, rooftop units, fire and security systems, elevator systems, thermostats, lighting, serviceable equipment (e.g., vending machines), and/or any other type of equipment that can be used to control, automate, or otherwise contribute to an environment, state, or condition of building 10. The terms “BMS devices,” “BMS device,” and “building equipment” are used interchangeably throughout this disclosure.

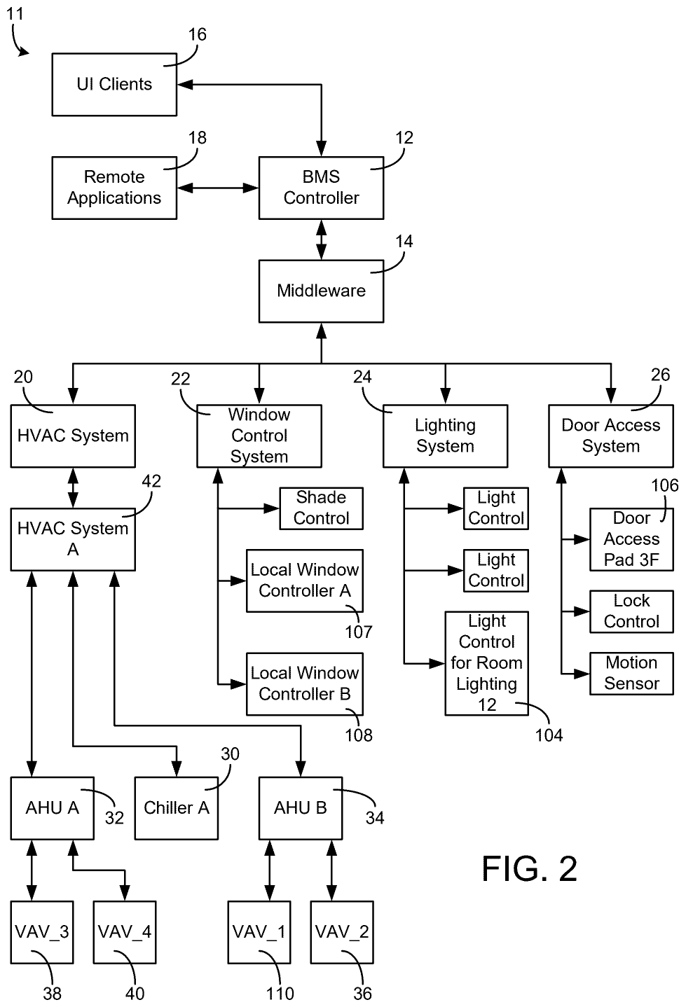

Referring now to FIG. 2, a block diagram of a BMS 11 for building 10 is shown, according to an exemplary embodiment. BMS 11 is shown to include a plurality of BMS subsystems 20-26. Each BMS subsystem 20-26 is connected to a plurality of BMS devices and makes data points for varying connected devices available to upstream BMS controller 12. Additionally, BMS subsystems 20-26 may encompass other lower-level subsystems. For example, an HVAC system may be broken down further as “HVAC system A,” “HVAC system B,” etc. In some buildings, multiple HVAC systems or subsystems may exist in parallel and may not be a part of the same HVAC system 20.

As shown in FIG. 2, BMS 11 may include a HVAC system 20. HVAC system 20 may control HVAC operations in building 10. HVAC system 20 is shown to include a lower-level HVAC system 42 (named “HVAC system A”). HVAC system 42 may control HVAC operations for a specific floor or zone of building 10. HVAC system 42 may be connected to air handling units (AHUs) 32, 34 (named “AHU A” and “AHU B,” respectively, in BMS 11). AHU 32 may serve variable air volume (VAV) boxes 38, 40 (named “VAV_3” and “VAV_4” in BMS 11). Likewise, AHU 34 may serve VAV boxes 36 and 110 (named “VAV_2”and “VAV_1”). HVAC system 42 may also include chiller 30 (named “Chiller A” in BMS 11). Chiller 30 may provide chilled fluid to AHU 32 and/or to AHU 34. HVAC system 42 may receive data (i.e., BMS inputs such as temperature sensor readings, damper positions, temperature setpoints, etc.) from AHUs 32, 34. HVAC system 42 may provide such BMS inputs to HVAC system 20 and on to middleware 14 and BMS controller 12. Similarly, other BMS subsystems may receive inputs from other building devices or objects and provide the received inputs to BMS controller 12 (e.g., via middleware 14).

Middleware 14 may include services that allow interoperable communication to, from, or between disparate BMS subsystems 20-26 of BMS 11 (e.g., HVAC systems from different manufacturers, HVAC systems that communicate according to different protocols, security/fire systems, IT resources, door access systems, etc.). Middleware 14 may be, for example, an EnNet server sold by Johnson Controls, Inc. While middleware 14 is shown as separate from BMS controller 12, middleware 14 and BMS controller 12 may integrated in some embodiments. For example, middleware 14 may be a part of BMS controller 12.

Still referring to FIG. 2, window control system 22 may receive shade control information from one or more shade controls, ambient light level information from one or more light sensors, and/or other BMS inputs (e.g., sensor information, setpoint information, current state information, etc.) from downstream devices. Window control system 22 may include window controllers 107, 108 (e.g., named “local window controller A” and “local window controller B,” respectively, in BMS 11). Window controllers 107, 108 control the operation of subsets of window control system 22. For example, window controller 108 may control window blind or shade operations for a given room, floor, or building in the BMS.

Lighting system 24 may receive lighting related information from a plurality of downstream light controls (e.g., from room lighting 104). Door access system 26 may receive lock control, motion, state, or other door related information from a plurality of downstream door controls. Door access system 26 is shown to include door access pad 106 (named “Door Access Pad 3F”), which may grant or deny access to a building space (e.g., a floor, a conference room, an office, etc.) based on whether valid user credentials are scanned or entered (e.g., via a keypad, via a badge-scanning pad, etc.).

BMS subsystems 20-26 may be connected to BMS controller 12 via middleware 14 and may be configured to provide BMS controller 12 with BMS inputs from various BMS subsystems 20-26 and their varying downstream devices. BMS controller 12 may be configured to make differences in building subsystems transparent at the human-machine interface or client interface level (e.g., for connected or hosted user interface (UI) clients 16, remote applications 18, etc.). BMS controller 12 may be configured to describe or model different building devices and building subsystems using common or unified objects (e.g., software objects stored in memory) to help provide the transparency. Software equipment objects may allow developers to write applications capable of monitoring and/or controlling various types of building equipment regardless of equipment-specific variations (e.g., equipment model, equipment manufacturer, equipment version, etc.). Software building objects may allow developers to write applications capable of monitoring and/or controlling building zones on a zone-by-zone level regardless of the building subsystem makeup.

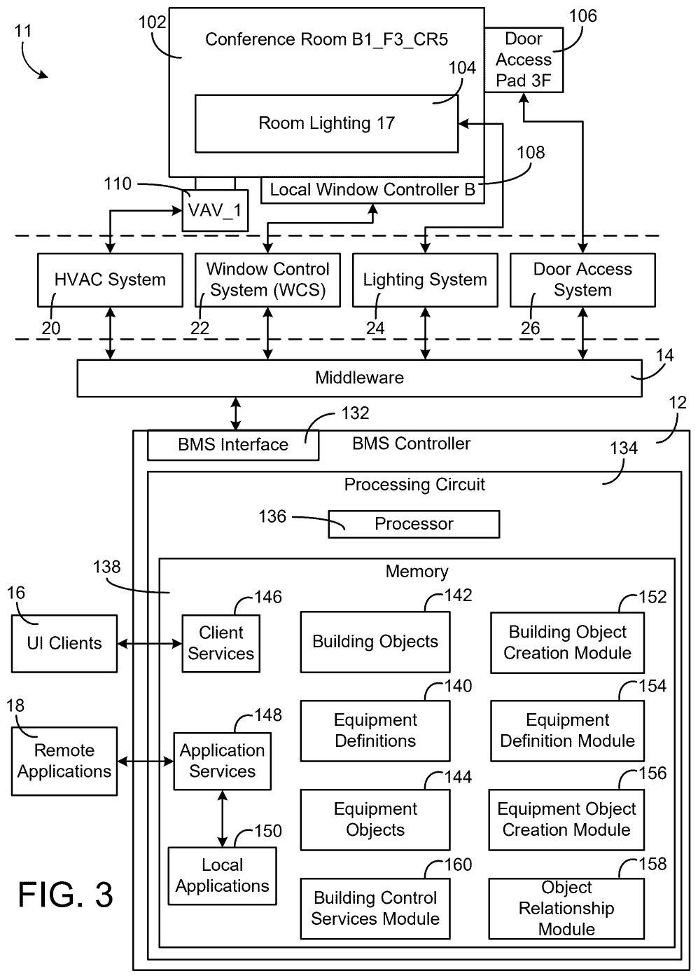

Referring now to FIG. 3, a block diagram illustrating a portion of BMS 11 in greater detail is shown, according to an exemplary embodiment. Particularly, FIG. 3 illustrates a portion of BMS 11 that services a conference room 102 of building 10 (named “B1_F3_CR5”). Conference room 102 may be affected by many different building devices connected to many different BMS subsystems. For example, conference room 102 includes or is otherwise affected by VAV box 110, window controller 108 (e.g., a blind controller), a system of lights 104 (named “Room Lighting 17”), and a door access pad 106.

Each of the building devices shown at the top of FIG. 3 may include local control circuitry configured to provide signals to their supervisory controllers or, more generally, to the BMS subsystems 20-26. The local control circuitry of the building devices shown at the top of FIG. 3 may also be configured to receive and respond to control signals, commands, setpoints, or other data from their supervisory controllers. For example, the local control circuitry of VAV box 110 may include circuitry that affects an actuator in response to control signals received from a field controller that is a part of HVAC system 20. Window controller 108 may include circuitry that affects windows or blinds in response to control signals received from a field controller that is part of window control system (WCS) 22. Room lighting 104 may include circuitry that affects the lighting in response to control signals received from a field controller that is part of lighting system 24. Access pad 106 may include circuitry that affects door access (e.g., locking or unlocking the door) in response to control signals received from a field controller that is part of door access system 26.

Still referring to FIG. 3, BMS controller 12 is shown to include a BMS interface 132 in communication with middleware 14. In some embodiments, BMS interface 132 is a communications interface. For example, BMS interface 132 may include wired or wireless interfaces (e.g., jacks, antennas, transmitters, receivers, transceivers, wire terminals, etc.) for conducting data communications with various systems, devices, or networks. BMS interface 132 can include an Ethernet card and port for sending and receiving data via an Ethernet-based communications network. In another example, BMS interface 132 includes a Wi-Fi transceiver for communicating via a wireless communications network. BMS interface 132 may be configured to communicate via local area networks or wide area networks (e.g., the Internet, a building WAN, etc.).

In some embodiments, BMS interface 132 and/or middleware 14 includes an application gateway configured to receive input from applications running on client devices. For example, BMS interface 132 and/or middleware 14 may include one or more wireless transceivers (e.g., a Wi-Fi transceiver, a Bluetooth transceiver, a NFC transceiver, a cellular transceiver, etc.) for communicating with client devices. BMS interface 132 may be configured to receive building management inputs from middleware 14 or directly from one or more BMS subsystems 20-26. BMS interface 132 and/or middleware 14 can include any number of software buffers, queues, listeners, filters, translators, or other communications-supporting services.

Still referring to FIG. 3, BMS controller 12 is shown to include a processing circuit 134 including a processor 136 and memory 138. Processor 136 may be a general purpose or specific purpose processor, an application specific integrated circuit (ASIC), one or more field programmable gate arrays (FPGAs), a group of processing components, or other suitable processing components. Processor 136 is configured to execute computer code or instructions stored in memory 138 or received from other computer readable media (e.g., CDROM, network storage, a remote server, etc.).

Memory 138 may include one or more devices (e.g., memory units, memory devices, storage devices, etc.) for storing data and/or computer code for completing and/or facilitating the various processes described in the present disclosure. Memory 138 may include random access memory (RAM), read-only memory (ROM), hard drive storage, temporary storage, non-volatile memory, flash memory, optical memory, or any other suitable memory for storing software objects and/or computer instructions. Memory 138 may include database components, object code components, script components, or any other type of information structure for supporting the various activities and information structures described in the present disclosure. Memory 138 may be communicably connected to processor 136 via processing circuit 134 and may include computer code for executing (e.g., by processor 136) one or more processes described herein. When processor 136 executes instructions stored in memory 138 for completing the various activities described herein, processor 136 generally configures BMS controller 12 (and more particularly processing circuit 134) to complete such activities.

Still referring to FIG. 3, memory 138 is shown to include building objects 142. In some embodiments, BMS controller 12 uses building objects 142 to group otherwise ungrouped or unassociated devices so that the group may be addressed or handled by applications together and in a consistent manner (e.g., a single user interface for controlling all of the BMS devices that affect a particular building zone or room). Building objects can apply to spaces of any granularity. For example, a building object can represent an entire building, a floor of a building, or individual rooms on each floor. In some embodiments, BMS controller 12 creates and/or stores a building object in memory 138 for each zone or room of building 10. Building objects 142 can be accessed by UI clients 16 and remote applications 18 to provide a comprehensive user interface for controlling and/or viewing information for a particular building zone. Building objects 142 may be created by building object creation module 152 and associated with equipment objects by object relationship module 158, described in greater detail below.

Still referring to FIG. 3, memory 138 is shown to include equipment definitions 140. Equipment definitions 140 stores the equipment definitions for various types of building equipment. Each equipment definition may apply to building equipment of a different type. For example, equipment definitions 140 may include different equipment definitions for variable air volume modular assemblies (VMAs), fan coil units, air handling units (AHUs), lighting fixtures, water pumps, and/or other types of building equipment.

Equipment definitions 140 define the types of data points that are generally associated with various types of building equipment. For example, an equipment definition for VMA may specify data point types such as room temperature, damper position, supply air flow, and/or other types of data measured or used by the VMA. Equipment definitions 140 allow for the abstraction (e.g., generalization, normalization, broadening, etc.) of equipment data from a specific BMS device so that the equipment data can be applied to a room or space.

Each of the equipment definitions 140 may include one or more point definitions. Each point definition may define a data point of a particular type and may include search criteria for automatically discovering and/or identifying data points that satisfy the point definition. An equipment definition can be applied to multiple pieces of building equipment of the same general type (e.g., multiple different VMA controllers). When an equipment definition is applied to a BMS device, the search criteria specified by the point definitions can be used to automatically identify data points provided by the BMS device that satisfy each point definition.

In some embodiments, equipment definitions 140 define data point types as generalized types of data without regard to the model, manufacturer, vendor, or other differences between building equipment of the same general type. The generalized data points defined by equipment definitions 140 allows each equipment definition to be referenced by or applied to multiple different variants of the same type of building equipment.

In some embodiments, equipment definitions 140 facilitate the presentation of data points in a consistent and user-friendly manner. For example, each equipment definition may define one or more data points that are displayed via a user interface. The displayed data points may be a subset of the data points defined by the equipment definition.

In some embodiments, equipment definitions 140 specify a system type (e.g., HVAC, lighting, security, fire, etc.), a system sub-type (e.g., terminal units, air handlers, central plants), and/or a data category (e.g., critical, diagnostic, operational) associated with the building equipment defined by each equipment definition. Specifying such attributes of building equipment at the equipment definition level allows the attributes to be applied to the building equipment along with the equipment definition when the building equipment is initially defined. Building equipment can be filtered by various attributes provided in the equipment definition to facilitate the reporting and management of equipment data from multiple building systems.

Equipment definitions 140 can be automatically created by abstracting the data points provided by archetypal controllers (e.g., typical or representative controllers) for various types of building equipment. In some embodiments, equipment definitions 140 are created by equipment definition module 154, described in greater detail below.

Still referring to FIG. 3, memory 138 is shown to include equipment objects 144. Equipment objects 144 may be software objects that define a mapping between a data point type (e.g., supply air temperature, room temperature, damper position) and an actual data point (e.g., a measured or calculated value for the corresponding data point type) for various pieces of building equipment. Equipment objects 144 may facilitate the presentation of equipment-specific data points in an intuitive and user-friendly manner by associating each data point with an attribute identifying the corresponding data point type. The mapping provided by equipment objects 144 may be used to associate a particular data value measured or calculated by BMS 11 with an attribute that can be displayed via a user interface.

Equipment objects 144 can be created (e.g., by equipment object creation module 156) by referencing equipment definitions 140. For example, an equipment object can be created by applying an equipment definition to the data points provided by a BMS device. The search criteria included in an equipment definition can be used to identify data points of the building equipment that satisfy the point definitions. A data point that satisfies a point definition can be mapped to an attribute of the equipment object corresponding to the point definition.

Each equipment object may include one or more attributes defined by the point definitions of the equipment definition used to create the equipment object. For example, an equipment definition which defines the attributes “Occupied Command,” “Room Temperature,” and “Damper Position”may result in an equipment object being created with the same attributes. The search criteria provided by the equipment definition are used to identify and map data points associated with a particular BMS device to the attributes of the equipment object. The creation of equipment objects is described in greater detail below with reference to equipment object creation module 156.

Equipment objects 144 may be related with each other and/or with building objects 142. Causal relationships can be established between equipment objects to link equipment objects to each other. For example, a causal relationship can be established between a VMA and an AHU which provides airflow to the VMA. Causal relationships can also be established between equipment objects 144 and building objects 142. For example, equipment objects 144 can be associated with building objects 142 representing particular rooms or zones to indicate that the equipment object serves that room or zone. Relationships between objects are described in greater detail below with reference to object relationship module 158.

Still referring to FIG. 3, memory 138 is shown to include client services 146 and application services 148. Client services 146 may be configured to facilitate interaction and/or communication between BMS controller 12 and various internal or external clients or applications. For example, client services 146 may include web services or application programming interfaces available for communication by UI clients 16 and remote applications 18 (e.g., applications running on a mobile device, energy monitoring applications, applications allowing a user to monitor the performance of the BMS, automated fault detection and diagnostics systems, etc.). Application services 148 may facilitate direct or indirect communications between remote applications 18, local applications 150, and BMS controller 12. For example, application services 148 may allow BMS controller 12 to communicate (e.g., over a communications network) with remote applications 18 running on mobile devices and/or with other BMS controllers.

In some embodiments, application services 148 facilitate an applications gateway for conducting electronic data communications with UI clients 16 and/or remote applications 18. For example, application services 148 may be configured to receive communications from mobile devices and/or BMS devices. Client services 146 may provide client devices with a graphical user interface that consumes data points and/or displays data defined by equipment definitions 140 and mapped by equipment objects 144.

Still referring to FIG. 3, memory 138 is shown to include a building object creation module 152. Building object creation module 152 may be configured to create the building objects stored in building objects 142. Building object creation module 152 may create a software building object for various spaces within building 10. Building object creation module 152 can create a building object for a space of any size or granularity. For example, building object creation module 152 can create a building object representing an entire building, a floor of a building, or individual rooms on each floor. In some embodiments, building object creation module 152 creates and/or stores a building object in memory 138 for each zone or room of building 10.

The building objects created by building object creation module 152 can be accessed by UI clients 16 and remote applications 18 to provide a comprehensive user interface for controlling and/or viewing information for a particular building zone. Building objects 142 can group otherwise ungrouped or unassociated devices so that the group may be addressed or handled by applications together and in a consistent manner (e.g., a single user interface for controlling all of the BMS devices that affect a particular building zone or room). In some embodiments, building object creation module 152 uses the systems and methods described in U.S. patent application No. Ser. No. 12/887,390, filed Sep. 21, 2010, for creating software defined building objects.

In some embodiments, building object creation module 152 provides a user interface for guiding a user through a process of creating building objects. For example, building object creation module 152 may provide a user interface to client devices (e.g., via client services 146) that allows a new space to be defined. In some embodiments, building object creation module 152 defines spaces hierarchically. For example, the user interface for creating building objects may prompt a user to create a space for a building, for floors within the building, and/or for rooms or zones within each floor.

In some embodiments, building object creation module 152 creates building objects automatically or semi-automatically. For example, building object creation module 152 may automatically define and create building objects using data imported from another data source (e.g., user view folders, a table, a spreadsheet, etc.). In some embodiments, building object creation module 152 references an existing hierarchy for BMS 11 to define the spaces within building 10. For example, BMS 11 may provide a listing of controllers for building 10 (e.g., as part of a network of data points) that have the physical location (e.g., room name) of the controller in the name of the controller itself. Building object creation module 152 may extract room names from the names of BMS controllers defined in the network of data points and create building objects for each extracted room. Building objects may be stored in building objects 142.

Still referring to FIG. 3, memory 138 is shown to include an equipment definition module 154. Equipment definition module 154 may be configured to create equipment definitions for various types of building equipment and to store the equipment definitions in equipment definitions 140. In some embodiments, equipment definition module 154 creates equipment definitions by abstracting the data points provided by archetypal controllers (e.g., typical or representative controllers) for various types of building equipment. For example, equipment definition module 154 may receive a user selection of an archetypal controller via a user interface. The archetypal controller may be specified as a user input or selected automatically by equipment definition module 154. In some embodiments, equipment definition module 154 selects an archetypal controller for building equipment associated with a terminal unit such as a VMA.

Equipment definition module 154 may identify one or more data points associated with the archetypal controller. Identifying one or more data points associated with the archetypal controller may include accessing a network of data points provided by BMS 11. The network of data points may be a hierarchical representation of data points that are measured, calculated, or otherwise obtained by various BMS devices. BMS devices may be represented in the network of data points as nodes of the hierarchical representation with associated data points depending from each BMS device. Equipment definition module 154 may find the node corresponding to the archetypal controller in the network of data points and identify one or more data points which depend from the archetypal controller node.

Equipment definition module 154 may generate a point definition for each identified data point of the archetypal controller. Each point definition may include an abstraction of the corresponding data point that is applicable to multiple different controllers for the same type of building equipment. For example, an archetypal controller for a particular VMA (i.e., “VMA-20”) may be associated with an equipment-specific data point such as “VMA-20.DPR-POS” (i.e., the damper position of VMA-20) and/or “VMA-20.SUP-FLOW” (i.e., the supply air flow rate through VMA-20). Equipment definition module 154 abstracts the equipment-specific data points to generate abstracted data point types that are generally applicable to other equipment of the same type. For example, equipment definition module 154 may abstract the equipment-specific data point “VMA-20.DPR-POS” to generate the abstracted data point type “DPR-POS” and may abstract the equipment-specific data point “VMA-20.SUP-FLOW” to generate the abstracted data point type “SUP-FLOW. ” Advantageously, the abstracted data point types generated by equipment definition module 154 can be applied to multiple different variants of the same type of building equipment (e.g., VMAs from different manufacturers, VMAs having different models or output data formats, etc.).

In some embodiments, equipment definition module 154 generates a user-friendly label for each point definition. The user-friendly label may be a plain text description of the variable defined by the point definition. For example, equipment definition module 154 may generate the label “Supply Air Flow” for the point definition corresponding to the abstracted data point type “SUP-FLOW” to indicate that the data point represents a supply air flow rate through the VMA. The labels generated by equipment definition module 154 may be displayed in conjunction with data values from BMS devices as part of a user-friendly interface.

In some embodiments, equipment definition module 154 generates search criteria for each point definition. The search criteria may include one or more parameters for identifying another data point (e.g., a data point associated with another controller of BMS 11 for the same type of building equipment) that represents the same variable as the point definition. Search criteria may include, for example, an instance number of the data point, a network address of the data point, and/or a network point type of the data point.

In some embodiments, search criteria include a text string abstracted from a data point associated with the archetypal controller. For example, equipment definition module 154 may generate the abstracted text string “SUP-FLOW” from the equipment-specific data point “VMA-20.SUP-FLOW. ” Advantageously, the abstracted text string matches other equipment-specific data points corresponding to the supply air flow rates of other BMS devices (e.g., “VMA-18.SUP-FLOW,” “SUP-FLOW. VMA-01,” etc.). Equipment definition module 154 may store a name, label, and/or search criteria for each point definition in memory 138.

Equipment definition module 154 may use the generated point definitions to create an equipment definition for a particular type of building equipment (e.g., the same type of building equipment associated with the archetypal controller). The equipment definition may include one or more of the generated point definitions. Each point definition defines a potential attribute of BMS devices of the particular type and provides search criteria for identifying the attribute among other data points provided by such BMS devices.

In some embodiments, the equipment definition created by equipment definition module 154 includes an indication of display data for BMS devices that reference the equipment definition. Display data may define one or more data points of the BMS device that will be displayed via a user interface. In some embodiments, display data are user defined. For example, equipment definition module 154 may prompt a user to select one or more of the point definitions included in the equipment definition to be represented in the display data. Display data may include the user-friendly label (e.g., “Damper Position”) and/or short name (e.g., “DPR-POS”) associated with the selected point definitions.

In some embodiments, equipment definition module 154 provides a visualization of the equipment definition via a graphical user interface. The visualization of the equipment definition may include a point definition portion which displays the generated point definitions, a user input portion configured to receive a user selection of one or more of the point definitions displayed in the point definition portion, and/or a display data portion which includes an indication of an abstracted data point corresponding to each of the point definitions selected via the user input portion. The visualization of the equipment definition can be used to add, remove, or change point definitions and/or display data associated with the equipment definitions.

Equipment definition module 154 may generate an equipment definition for each different type of building equipment in BMS 11 (e.g., VMAs, chillers, AHUs, etc.). Equipment definition module 154 may store the equipment definitions in a data storage device (e.g., memory 138, equipment definitions 140, an external or remote data storage device, etc.).

Still referring to FIG. 3, memory 138 is shown to include an equipment object creation module 156. Equipment object creation module 156 may be configured to create equipment objects for various BMS devices. In some embodiments, equipment object creation module 156 creates an equipment object by applying an equipment definition to the data points provided by a BMS device. For example, equipment object creation module 156 may receive an equipment definition created by equipment definition module 154. Receiving an equipment definition may include loading or retrieving the equipment definition from a data storage device.

In some embodiments, equipment object creation module 156 determines which of a plurality of equipment definitions to retrieve based on the type of BMS device used to create the equipment object. For example, if the BMS device is a VMA, equipment object creation module 156 may retrieve the equipment definition for VMAs; whereas if the BMS device is a chiller, equipment object creation module 156 may retrieve the equipment definition for chillers. The type of BMS device to which an equipment definition applies may be stored as an attribute of the equipment definition. Equipment object creation module 156 may identify the type of BMS device being used to create the equipment object and retrieve the corresponding equipment definition from the data storage device.

In other embodiments, equipment object creation module 156 receives an equipment definition prior to selecting a BMS device. Equipment object creation module 156 may identify a BMS device of BMS 11 to which the equipment definition applies. For example, equipment object creation module 156 may identify a BMS device that is of the same type of building equipment as the archetypal BMS device used to generate the equipment definition. In various embodiments, the BMS device used to generate the equipment object may be selected automatically (e.g., by equipment object creation module 156), manually (e.g., by a user), or semi-automatically (e.g., by a user in response to an automated prompt from equipment object creation module 156).

In some embodiments, equipment object creation module 156 creates an equipment discovery table based on the equipment definition. For example, equipment object creation module 156 may create an equipment discovery table having attributes (e.g., columns) corresponding to the variables defined by the equipment definition (e.g., a damper position attribute, a supply air flow rate attribute, etc.). Each column of the equipment discovery table may correspond to a point definition of the equipment definition. The equipment discovery table may have columns that are categorically defined (e.g., representing defined variables) but not yet mapped to any particular data points.

Equipment object creation module 156 may use the equipment definition to automatically identify one or more data points of the selected BMS device to map to the columns of the equipment discovery table. Equipment object creation module 156 may search for data points of the BMS device that satisfy one or more of the point definitions included in the equipment definition. In some embodiments, equipment object creation module 156 extracts a search criterion from each point definition of the equipment definition. Equipment object creation module 156 may access a data point network of the building automation system to identify one or more data points associated with the selected BMS device. Equipment object creation module 156 may use the extracted search criterion to determine which of the identified data points satisfy one or more of the point definitions.

In some embodiments, equipment object creation module 156 automatically maps (e.g., links, associates, relates, etc.) the identified data points of the selected BMS device to the equipment discovery table. A data point of the selected BMS device may be mapped to a column of the equipment discovery table in response to a determination by equipment object creation module 156 that the data point satisfies the point definition (e.g., the search criteria) used to generate the column. For example, if a data point of the selected BMS device has the name “VMA-18.SUP-FLOW” and a search criterion is the text string “SUP-FLOW,” equipment object creation module 156 may determine that the search criterion is met. Accordingly, equipment object creation module 156 may map the data point of the selected BMS device to the corresponding column of the equipment discovery table.

Advantageously, equipment object creation module 156 may create multiple equipment objects and map data points to attributes of the created equipment objects in an automated fashion (e.g., without human intervention, with minimal human intervention, etc.). The search criteria provided by the equipment definition facilitates the automatic discovery and identification of data points for a plurality of equipment object attributes. Equipment object creation module 156 may label each attribute of the created equipment objects with a device-independent label derived from the equipment definition used to create the equipment object. The equipment objects created by equipment object creation module 156 can be viewed (e.g., via a user interface) and/or interpreted by data consumers in a consistent and intuitive manner, regardless of device-specific differences between BMS devices of the same general type. The equipment objects created by equipment object creation module 156 may be stored in equipment objects 144.

Still referring to FIG. 3, memory 138 is shown to include an object relationship module 158. Object relationship module 158 may be configured to establish relationships between equipment objects 144. In some embodiments, object relationship module 158 establishes causal relationships between equipment objects 144 based on the ability of one BMS device to affect another BMS device. For example, object relationship module 158 may establish a causal relationship between a terminal unit (e.g., a VMA) and an upstream unit (e.g., an AHU, a chiller, etc.), which affects an input provided to the terminal unit (e.g., air flow rate, air temperature, etc.).

Object relationship module 158 may establish relationships between equipment objects 144 and building objects 142 (e.g., spaces). For example, object relationship module 158 may associate equipment objects 144 with building objects 142 representing particular rooms or zones to indicate that the equipment object serves that room or zone. In some embodiments, object relationship module 158 provides a user interface through which a user can define relationships between equipment objects 144 and building objects 142. For example, a user can assign relationships in a “drag and drop” fashion by dragging and dropping a building object and/or an equipment object into a “serving” cell of an equipment object provided via the user interface to indicate that the BMS device represented by the equipment object serves a particular space or BMS device.

Still referring to FIG. 3, memory 138 is shown to include a building control services module 160. Building control services module 160 may be configured to automatically control BMS 11 and the various subsystems thereof. Building control services module 160 may utilize closed loop control, feedback control, PI control, model predictive control, or any other type of automated building control methodology to control the environment (e.g., a variable state or condition) within building 10.

Building control services module 160 may receive inputs from sensory devices (e.g., temperature sensors, pressure sensors, flow rate sensors, humidity sensors, electric current sensors, cameras, radio frequency sensors, microphones, etc.), user input devices (e.g., computer terminals, client devices, user devices, etc.), or other data input devices via BMS interface 132. Building control services module 160 may apply the various inputs to a building energy use model and/or a control algorithm to determine an output for one or more building control devices (e.g., dampers, air handling units, chillers, boilers, fans, pumps, etc.) in order to affect a variable state or condition within building 10 (e.g., zone temperature, humidity, air flow rate, etc.).

In some embodiments, building control services module 160 is configured to control the environment of building 10 on a zone-individualized level. For example, building control services module 160 may control the environment of two or more different building zones using different setpoints, different constraints, different control methodologies, and/or different control parameters. Building control services module 160 may operate BMS 11 to maintain building conditions (e.g., temperature, humidity, air quality, etc.) within a setpoint range, to optimize energy performance (e.g., to minimize energy consumption, to minimize energy cost, etc.), and/or to satisfy any constraint or combination of constraints as may be desirable for various implementations.

In some embodiments, building control services module 160 uses the location of various BMS devices to translate an input received from a building system into an output or control signal for the building system. Building control services module 160 may receive location information for BMS devices and automatically set or recommend control parameters for the BMS devices based on the locations of the BMS devices. For example, building control services module 160 may automatically set a flow rate setpoint for a VAV box based on the size of the building zone in which the VAV box is located.

Building control services module 160 may determine which of a plurality of sensors to use in conjunction with a feedback control loop based on the locations of the sensors within building 10. For example, building control services module 160 may use a signal from a temperature sensor located in a building zone as a feedback signal for controlling the temperature of the building zone in which the temperature sensor is located.

In some embodiments, building control services module 160 automatically generates control algorithms for a controller or a building zone based on the location of the zone in the building 10. For example, building control services module 160 may be configured to predict a change in demand resulting from sunlight entering through windows based on the orientation of the building and the locations of the building zones (e.g., east-facing, west-facing, perimeter zones, interior zones, etc.).

Building control services module 160 may use zone location information and interactions between adjacent building zones (rather than considering each zone as an isolated system) to more efficiently control the temperature and/or airflow within building 10. For control loops that are conducted at a larger scale (i.e., floor level), building control services module 160 may use the location of each building zone and/or BMS device to coordinate control functionality between building zones. For example, building control services module 160 may consider heat exchange and/or air exchange between adjacent building zones as a factor in determining an output control signal for the building zones.

In some embodiments, building control services module 160 is configured to optimize the energy efficiency of building 10 using the locations of various BMS devices and the control parameters associated therewith. Building control services module 160 may be configured to achieve control setpoints using building equipment with a relatively lower energy cost (e.g., by causing airflow between connected building zones) in order to reduce the loading on building equipment with a relatively higher energy cost (e.g., chillers and roof top units). For example, building control services module 160 may be configured to move warmer air from higher elevation zones to lower elevation zones by establishing pressure gradients between connected building zones.

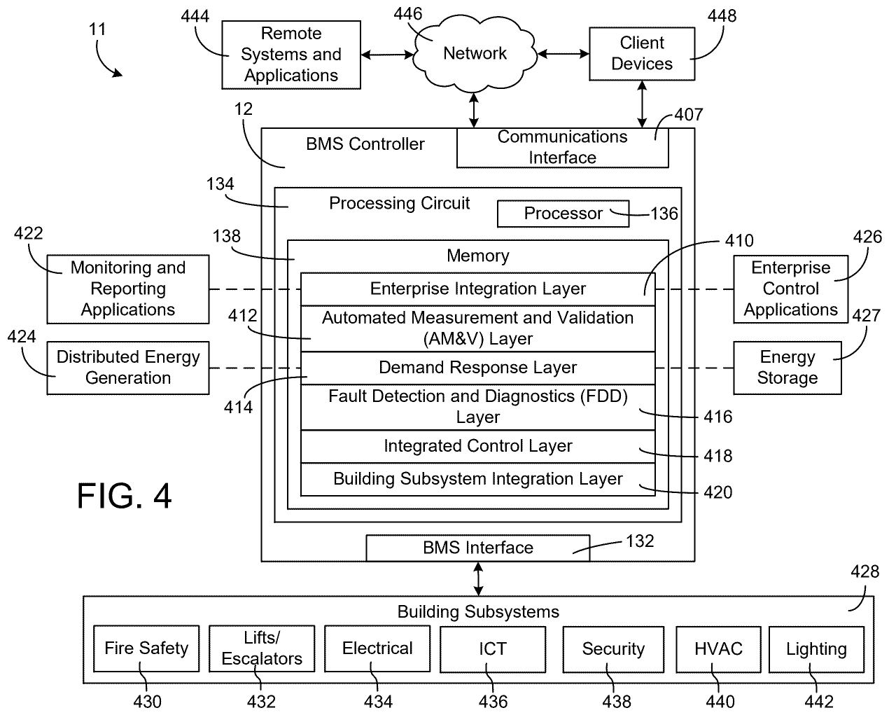

Referring now to FIG. 4, another block diagram illustrating a portion of BMS 11 in greater detail is shown, according to some embodiments. BMS 11 can be implemented in building 10 to automatically monitor and control various building functions. BMS 11 is shown to include BMS controller 12 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10.

Each of building subsystems 428 can include any number of devices, controllers, and connections for completing its individual functions and control activities. HVAC subsystem 440 can include many of the same components as HVAC system 20, as described with reference to FIGS. 2-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 12 is shown to include a communications interface 407 and a BMS interface 132. Interface 407 may facilitate communications between BMS controller 12 and external applications (e.g., monitoring and reporting applications 422, enterprise control applications 426, remote systems and applications 444, applications residing on client devices 448, etc.) for allowing user control, monitoring, and adjustment to BMS controller 12 and/or subsystems 428. Interface 407 may also facilitate communications between BMS controller 12 and client devices 448. BMS interface 132 may facilitate communications between BMS controller 12 and building subsystems 428 (e.g., HVAC, lighting security, lifts, power distribution, business, etc.).

Interfaces 407, 132 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 132 can be direct (e.g., local wired or wireless communications) or via a communications network 446 (e.g., a WAN, the Internet, a cellular network, etc.). For example, interfaces 407, 132 can include an Ethernet card and port for sending and receiving data via an Ethernet-based communications link or network. In another example, interfaces 407, 132 can include a Wi-Fi transceiver for communicating via a wireless communications network. In another example, one or both of interfaces 407, 132 can include cellular or mobile phone communications transceivers. In one embodiment, communications interface 407 is a power line communications interface and BMS interface 132 is an Ethernet interface. In other embodiments, both communications interface 407 and BMS interface 132 are Ethernet interfaces or are the same Ethernet interface.

Still referring to FIG. 4, BMS controller 12 is shown to include a processing circuit 134 including a processor 136 and memory 138. Processing circuit 134 can be communicably connected to BMS interface 132 and/or communications interface 407 such that processing circuit 134 and the various components thereof can send and receive data via interfaces 407, 132. Processor 136 can be implemented as a general purpose processor, an application specific integrated circuit (ASIC), one or more field programmable gate arrays (FPGAs), a group of processing components, or other suitable electronic processing components.

Memory 138 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 138 can be or include volatile memory or non-volatile memory. Memory 138 can include database components, object code components, script components, or any other type of information structure for supporting the various activities and information structures described in the present application. According to some embodiments, memory 138 is communicably connected to processor 136 via processing circuit 134 and includes computer code for executing (e.g., by processing circuit 134 and/or processor 136) one or more processes described herein.

In some embodiments, BMS controller 12 is implemented within a single computer (e.g., one server, one housing, etc.). In various other embodiments, BMS controller 12 can be distributed across multiple servers or computers (e.g., that can exist in distributed locations). Further, while FIG. 4 shows applications 422 and 426 as existing outside of BMS controller 12, in some embodiments, applications 422 and 426 can be hosted within BMS controller 12 (e.g., within memory 138).

Still referring to FIG. 4, memory 138 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 11.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also, or alternatively, be configured to provide configuration GUIs for configuring BMS controller 12. In yet other embodiments, enterprise control applications 426 can work with layers 410-420 to optimize building performance (e.g., efficiency, energy use, comfort, or safety) based on inputs received at interface 407 and/or BMS interface 132.

Building subsystem integration layer 420 can be configured to manage communications between BMS controller 12 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translates communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfying the demand of building 10. The optimization can be based on time-of-use prices, curtailment signals, energy availability, or other data received from utility providers, distributed energy generation systems 424, energy storage 427, or other sources. Demand response layer 414 may receive inputs from other layers of BMS controller 12 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response layer 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained, even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418, which executes control strategies and policies in response to the received fault events. According to some embodiments, FDD layer 416 (or a policy executed by an integrated control engine or business rules engine) may shut down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 11 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Air Handling Unit System

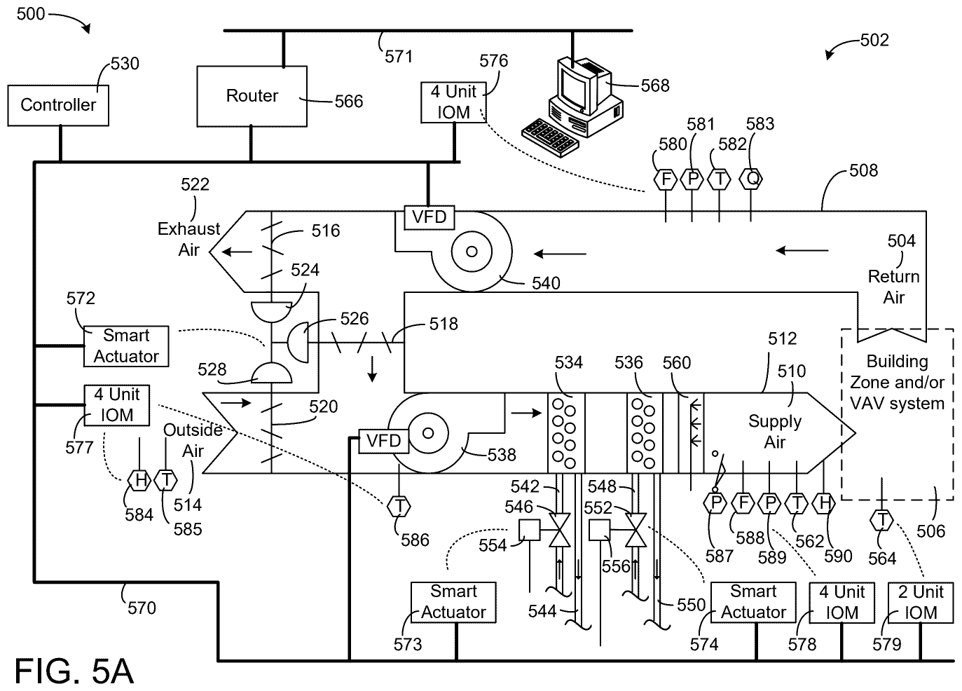

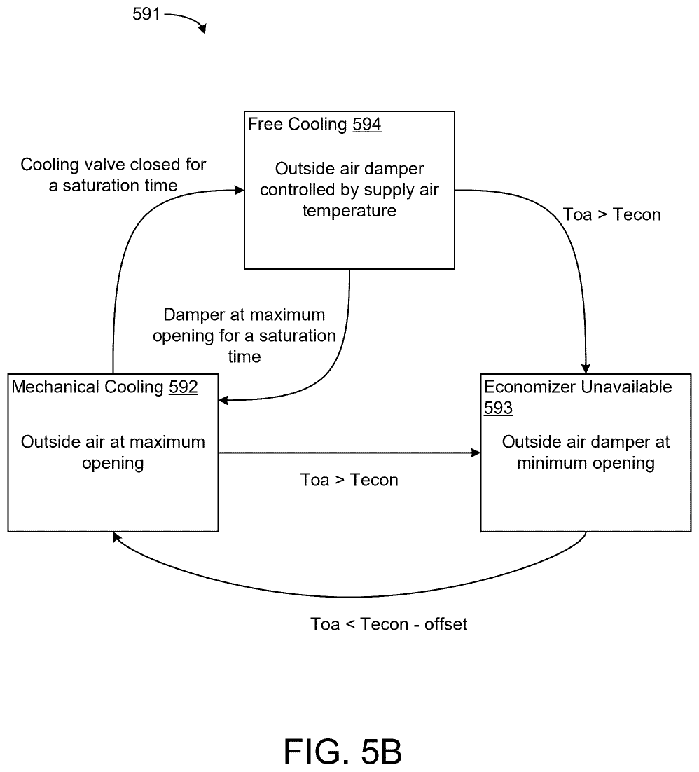

Referring now to FIG. 5A, a block diagram of an airside system 500 is shown, according to some embodiments. Airside system 500 may be controlled by one or more controllers, including controller 530. Airside system 500 can include additional HVAC devices to form an HVAC system (e.g., AHUs, VAVs, ducts, fans, dampers, etc.) and can be located in or around building 10. Airside system 500 may operate to heat or cool an airflow provided to building 10 using a heated or chilled fluid provided by a waterside system.

In FIG. 5A, airside system 500 is shown to include an economizer-type air handling unit (AHU) 502. Economizer-type AHUs vary the amount of outside air and return air used by the air handling unit for heating or cooling. For example, AHU 502 may receive return air 504 from building zone 506 via return air duct 508 and may deliver supply air 510 to building zone 506 via supply air duct 512. In some embodiments, AHU 502 is a rooftop unit located on the roof of building 10 or otherwise positioned to receive both return air 504 and outside air 514. AHU 502 can be configured to operate exhaust air damper 516, mixing damper 518, and outside air damper 520 to control an amount of outside air 514 and return air 504 that combine to form supply air 510. Any return air 504 that does not pass through mixing damper 518 can be exhausted from AHU 502 through exhaust damper 516 as exhaust air 522.

Each of dampers 516-520 can be operated by an actuator. For example, exhaust air damper 516 can be operated by actuator 524, mixing damper 518 can be operated by actuator 526, and outside air damper 520 can be operated by actuator 528. Actuators 524-528 may communicate with an AHU controller 530 via a communications link 532. Actuators 524-528 may receive control signals from AHU controller 530 and may provide feedback signals to AHU controller 530. Feedback signals can include, for example, an indication of a current actuator or damper position, an amount of torque or force exerted by the actuator, diagnostic information (e.g., results of diagnostic tests performed by actuators 524-528), status information, commissioning information, configuration settings, calibration data, and/or other types of information or data that can be collected, stored, or used by actuators 524-528. AHU controller 530 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 524-528.

Still referring to FIG. 5A, AHU 502 is shown to include a cooling coil 534, a heating coil 536, and a fan 538 positioned within supply air duct 512. Fan 538 can be configured to force supply air 510 through cooling coil 534 and/or heating coil 536 and provide supply air 510 to building zone 506. AHU controller 530 may communicate with fan 538 via a communications link to control a flow rate of supply air 510. In some embodiments, AHU controller 530 controls an amount of heating or cooling applied to supply air 510 by modulating a speed of fan 538. In some embodiments, AHU 602 includes a return fan positioned within the return duct 508. The return fan may, for example, be used in order balance air supplied to and returned from the building zone. In some embodiments, AHU 502 includes a humidifier 560. Humidifier 560 may be configured to spray or otherwise wet a medium that allows evaporation of the water into the supply air as it traverses duct 512.

Cooling coil 534 may receive a chilled fluid from a waterside system (via piping 542 and may return the chilled fluid to the waterside system via piping 544. Valve 546 can be positioned along piping 542 or piping 544 to control a flow rate of the chilled fluid through cooling coil 534. In some embodiments, cooling coil 534 includes multiple stages of cooling coils that can be independently activated and deactivated (e.g., by AHU controller 530, by supervisory controller 566, etc.) to modulate an amount of cooling applied to supply air 510.

Heating coil 536 may receive a heated fluid from the waterside system via piping 548 and may return the heated fluid to the waterside system via piping 550. Valve 552 can be positioned along piping 548 or piping 550 to control a flow rate of the heated fluid through heating coil 536. In some embodiments, heating coil 536 includes multiple stages of heating coils that can be independently activated and deactivated (e.g., by AHU controller 530, by supervisory controller 566, etc.) to modulate an amount of heating applied to supply air 510.

Each of valves 546 and 552 can be controlled by an actuator. For example, valve 546 can be controlled by actuator 554, and valve 552 can be controlled by actuator 556. Actuators 554-556 may communicate with AHU controller 530 via communications links. Actuators 554-556 may receive control signals from AHU controller 530 and may provide feedback signals to controller 530. In some embodiments, AHU controller 530 receives a measurement of the supply air temperature from a temperature sensor 562 positioned in supply air duct 512 (e.g., downstream of cooling coil 534 and/or heating coil 536). AHU controller 530 may also receive a measurement of the temperature of building zone 506 from a temperature sensor 564 located in building zone 506.

In some embodiments, AHU controller 530 operates valves 546 and 552 via actuators 554-556 to modulate an amount of heating or cooling provided to supply air 510 (e.g., to achieve a setpoint temperature for supply air 510 or to maintain the temperature of supply air 510 within a setpoint temperature range). The positions of valves 546 and 552 affect the amount of heating or cooling provided to supply air 510 by cooling coil 534 or heating coil 536 and may correlate with the amount of energy consumed to achieve a desired supply air temperature. AHU controller 530 may control the temperature of supply air 510 and/or building zone 506 by activating or deactivating coils 534-536, adjusting a speed of fan 538, or a combination of both.

Still referring to FIG. 5A, airside system 500 is shown to include a supervisory controller and/or router 566 and a client device 568. Supervisory controller and/or router 566 can include one or more computer systems (e.g., servers, supervisory controllers, subsystem controllers, etc.) that serve as system level controllers, application or data servers, head nodes, or master controllers for airside system 500, a waterside system, a HVAC system, and/or other controllable systems that serve building 10. Supervisory controller and/or 566 may communicate with multiple downstream building systems or subsystems (e.g., a HVAC system, a security system, a lighting system, a waterside system, etc.) via a communications link 570 according to like or disparate protocols (e.g., LON, BACnet, etc.). In various embodiments, AHU controller 530 and supervisory controller 566 can be separate (as shown in FIG. 5A) or integrated. In an integrated implementation, AHU controller 530 can be a software module configured for execution by a processor of supervisory controller 566.

In some embodiments, AHU controller 530 receives information from supervisory controller 566 (e.g., commands, setpoints, operating boundaries, etc.) and provides information to supervisory controller 566 (e.g., temperature measurements, valve or actuator positions, operating statuses, diagnostics, etc.). For example, AHU controller 530 may provide supervisory controller 566 with temperature measurements from temperature sensors 562-564, equipment on/off states, equipment operating capacities, and/or any other information that can be used by supervisory controller 566 to monitor or control a variable state or condition within building zone 506.

Client device 568 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with a HVAC system, its subsystems, and/or devices. Client device 568 can be a computer workstation, a client terminal, a remote or local interface, or any other type of user interface device. Client device 568 can be a stationary terminal or a mobile device. For example, client device 568 can be a desktop computer, a computer server with a user interface, a laptop computer, a tablet, a smartphone, a PDA, or any other type of mobile or non-mobile device. Client device 568 may communicate with supervisory controller 566 and/or AHU controller 530 via communications link 572.

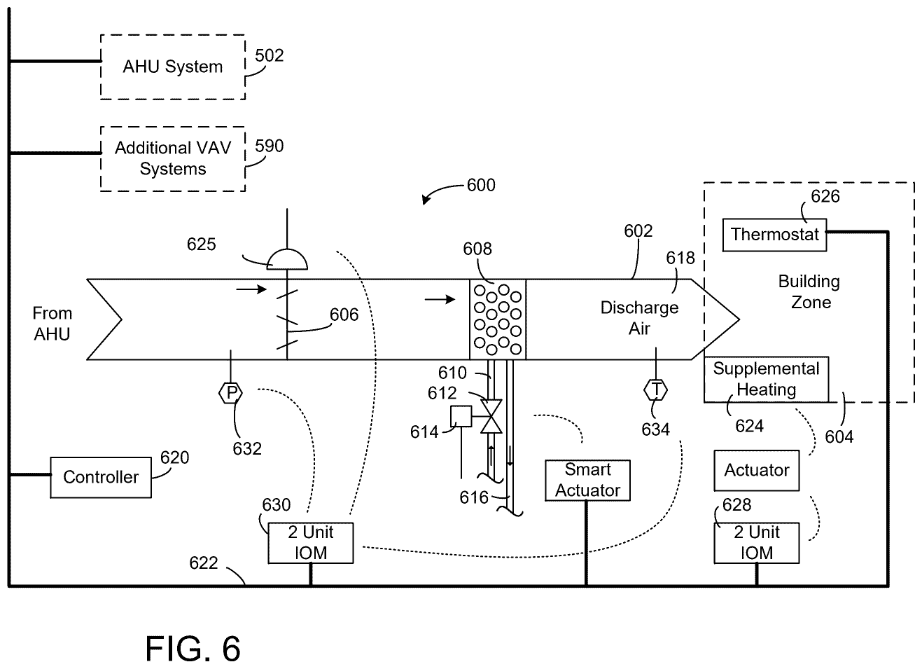

With reference to FIG. 6, a variable air volume (VAV) system 600 is shown, according to some embodiments. VAV system 600 may be configured with duct 602 to receive air from an AHU (e.g., AHU 502). In some embodiments, the AHU provides air at a temperature capable of cooling building zone 604. Damper 606 may be configured to control the amount of air that enters building zone 604, for example to control the cooling effect of the air and maintain building zone 604 at a setpoint temperature. VAV system 600 may be configured with a reheat coil 608 to provide heating when needed (e.g., in the winter or under low load conditions).

Reheat coil 608 may be supplied with hot water, steam, or other fluid from a waterside system via pipe 610. Water may be returned via pipe 616 back to the waterside system. In some embodiments, the amount of water flow (and thus the amount of heating effect) is controlled by valve 612 via actuator motor 614, for example, to maintain the discharge air 618 temperature at a setpoint temperature or the temperature of the building zone 604 at a setpoint temperature.

Building zone 604 may be configured with supplemental heating 624 (e.g., a perimeter heating system) to provide heating in addition to or instead of reheat coil 608. Building zone 604 may be configured with a separate thermostat 626 to provide measurements of the zone air temperature and/or to provide a temperature setpoint (or a warm/cool adjustment from a common setpoint) representing the desired temperature for occupants of building zone 604. In some embodiments, thermostat 626 may be connected to a control network 622.

In some embodiments, controller 620 operates the valve and damper motors in order to control the physical conditions of the VAV system 600 and/or building zone 604. Communication between sensors, actuators, and controller 620 may be performed over network 622. In some embodiments, IOMs (e.g., IOM 628 and 630) are used to connect to sensors and/or actuators. For example, to convert an analog voltage signal from a sensor to a digital communication and/or to convert a digital communication of an actuator position into an analog control signal for a servo motor, network 622 may use any type of communications protocol (e.g., a token passing protocol, an internet protocol, or polling). In some embodiments, an AHU (e.g., AHU 502) provides conditioned air to multiple VAV systems. AHU system 502 and additional VAV systems 590 may be on the same network 622 as controller 620, or they may be on other networks. In some embodiments, controller 620 provides the control calculations, signals, and commands to AHU system 502 and additional VAV systems 590. In some embodiments, other controllers (e.g., similar to controller 620) provide control for the other systems. The other controllers may be on the same network as controller 620.

### Deterministic Communications in Building Management Systems

Referring again to FIG. 5A, control of AHU 502 is provided by controller 530 over network 570 according to some embodiments. Network 570 may allow for communication between several building control devices. Devices connected to network 570 may include smart actuators (e.g., smart actuators 572-574), one or more controllers (e.g., controller 530), a supervisory controller and/or router (e.g., router 566), input-output modules (IOMs) (e.g., IOMs 576-579), and variable frequency drives (VFD) (e.g., VFD 538 and 540). To provide feedback measurements for control of AHU 502, IOMs may be connected to various sensors and limit switches (e.g., sensors 580-590 including pressure limit switch 587) using a wired analog voltage signal. Relationships between IOMs and the sensors to which they are connected are represented by dotted lines in FIG. 5A. Smart actuators may also be connected to network 570. In some embodiments, smart actuators provide an actuator (e.g., motor), digital-to-analog conversion, and communications in a single package and are used to control valves and/or dampers. Dotted lines are also used to relate a smart actuator to a control point in FIG. 5A. Variable speed fans may include VFDs that are capable of receiving speed (or frequency) commands directly on the digital communications network 570.

In some embodiments, a second network (e.g., network 571) may be included to provide connectivity to user devices (e.g., user device 568). For example, network 571 may receive information from devices on network 570 through router 566 to a user dashboard or interface provided on user device 568. Routing may be provided by a router, network engine, supervisory controller, or other device capable of routing information between networks 570 and 571. For example, a supervisory controller may connect to both a BACnet MS/TP token passing network using a serial RS-485 interface and an IP network using an ethernet physical layer.

Several types of communications or messages may be sent over network 570. In some embodiments, controller 530 may periodically poll for information from any of the IOMs related to sensors that are connected to the IOM. In some embodiments, the IOM may periodically send messages on network 570 to announce the current value of any sensor to which it is connected. In some embodiments, controller 530 may subscribe to a change-of-value (COV) with an IOM. The IOM may then send a new sensor value to the controller anytime the sensed value has changed by more than a specified amount (e.g., an amount provided in the characteristics of the COV configuration). In some embodiments, controller 530 may periodically send commands to any of the smart actuators on network 570. In some embodiments, router 566 may request values or subscribe to COVs for any of the devices connected to network 570. Router 566 may then communicate that information to devices (e.g., for display, storage, or processing) on network 571. In some embodiments, other forms of communication are performed on network 570.

The communication load on network 570 may be unpredictable and/or not distributed evenly over time. For example, the number of communications sent on network 570 may be elevated at certain times of the day (e.g., system startup) when more physical conditions are changing and thus more COVs are being set. At times, communications traffic may be high enough to cause latency or delay for communications provided on network 570. In some embodiments, controller 530 operates on a low baud rate (e.g., 32000) token passing network and is unable to communicate until the communication token has been passed through all other manager devices on the network. In some embodiments, controller 530 operates on a polling network and all sensors are periodically polled for data. Delays in communications may cause poor or even unstable control, especially in fast acting control loops such as pressure control. Advantageously, the present disclosure provides systems and methods by which controllers are able to enter a deterministic communications mode and provide/receive prioritized communications on the network. In some embodiments, the deterministic mode is entered in response to an algorithm on the controller entering an active control mode.

The controllers on network 570 may be responsible for providing control using several control algorithms. Each control algorithm may operate in one of many states (or modes), each requiring different sensor telemetry to perform the necessary function. COVs subscribed may be configured for the speed of communication and accuracy necessary during active control. With reference to FIG. 5B, controller 530 executes economizer damper control in some embodiments. The economizer cooling control algorithm 591 has three states in some embodiments. Economizer control algorithm may include mechanical cooling mode 592, economizer unavailable mode 593, and free cooling mode 594. Various conditions may cause the algorithm to transition from one state to another. For example, if the outside air temperature (Toa) becomes greater than an economizer availability threshold (Tecon), economizer cooling control algorithm 591 may transition to economizer unavailable mode 593. According to some embodiments, in mechanical cooling mode 592 the economizer damper remains at its maximum opening, and in economizer unavailable mode 593 the economizer damper remains at its minimum opening. Thus, in some embodiments, the outside air damper is only modulated to maintain a supply air temperature in one of the three modes of operation. For example, control algorithm 591 only requires measurements of the supply air temperature when in active control mode free cooling mode 594. Various control algorithms may have other sets of modes, some of which may include an active control loop. Active control modes may be entered based on a transition defined by a variable (e.g., the transitions shown in FIG. 5B), based on schedules (e.g., at the beginning of the occupied portion of the day), or based on the operational sequence of the device (e.g., during the performance of calculations for a particular portion of a control algorithm).

Referring back to FIG. 5A, AHU 502 may have several active control modes, according to some embodiments. In some modes, supply air 510 may be actively controlled by cooling valve 546. In some modes, supply air 510 may be actively controlled by heating valve 552. In some modes, duct static pressure measured by sensor 589 may be actively controlled by supply fan 538. In some modes, supply air humidity may be controlled by humidifier 560. In some modes, building static pressure, may be controlled by return fan 540. Communication of values used to control these conditions may compete with other network traffic on network 570, including traffic used for display rather than active control. Systems and methods of the present application advantageously provide the ability to enter a mode that prioritizes certain communications in some embodiments. Prioritized communications related to active control may ensure timely delivery of control commands to actuators thus providing improved control. Prioritized control may also make it possible to control fast systems (e.g., pressure control) on slower networks with many connected devices.

Referring again to FIG. 6, additional active control algorithms and modes may be provided for VAV control. For example, velocity pressure (as measured by sensor 632) may be controlled by damper 606 via damper motor 625. Building zone temperature may be controlled by supplemental heating 624, by damper 606, and/or by reheat coil 608 (via valve 612). The number of potential active control algorithms that may run in a controller on network 622 is quite large, especially if multiple VAV control systems and the AHU control system are connected to the same network.

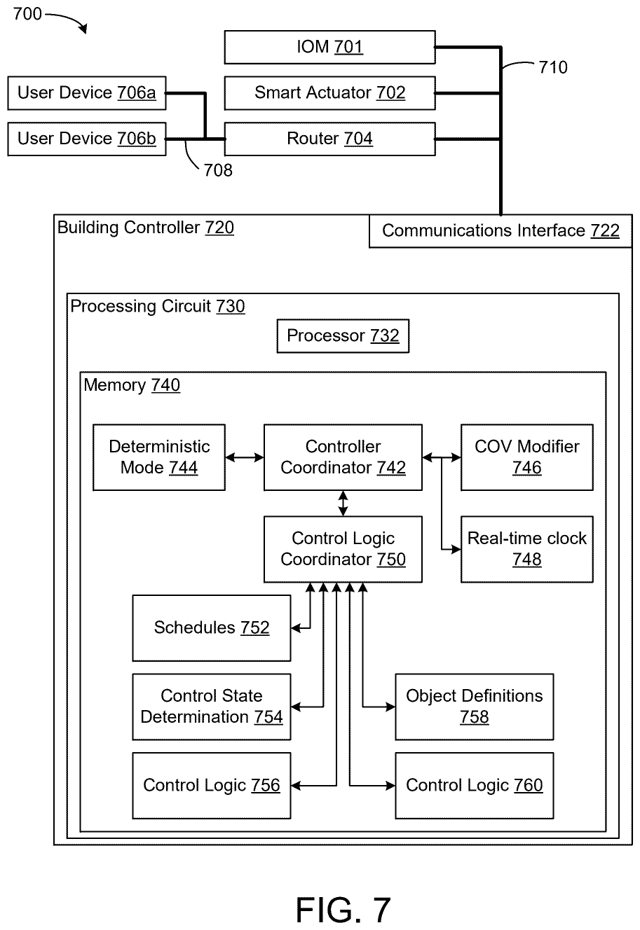

With reference to FIG. 7, building management system 700 is depicted according to some embodiments. Building management system 700 is depicted with building controller 720 on network 710. Network 710 may include additional building controllers (e.g., similar to building controller 720), one or more IOMs (e.g., IOM 701), one or more smart actuators (e.g., smart actuator 702), and one or more routers (e.g., router 704). Router 704 may be a supervisory controller, network engine, or other device capable of communicating on networks 710 and 708. In some embodiments, router 704 is configured to route information between a user device (e.g., user device 706a-b) and devices on network 710. For example, user device 706a may be displaying information related to the control of equipment by building controller 720 and user device 706b may be used to configure building controller 720 (e.g., set setpoints, change a schedule, etc.).

Building controller 720 may include a communications interface 722 to communicate with other devices on network 710 (e.g., receive a measurement from IOM 701). Building controller 720 may include one or more processing circuits with one or more processors (e.g., processor 732) and one or more memory devices (e.g., memory 740). The various modules with instructions depicted as stored in memory 740 may be distributed over several memory devices or all contained in a single memory device. The processors may be a general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.). The processors may be configured in various computer architectures, such as graphics processing units (GPUs). The memories may include one or more devices (e.g., memory units, memory devices, storage devices, etc.) for storing data and/or computer code for completing and/or facilitating the various processes described in the present disclosure. The memories may include random access memory (RAM), read-only memory (ROM), hard drive storage, temporary storage, non-volatile memory, flash memory, optical memory, or any other suitable memory for storing software objects and/or computer instructions. The memories may include database components, object code components, script components, or any other type of information structure for supporting the various activities and information structures described in the present disclosure. The memories may be communicably connected to the processors and can include computer code for executing (e.g., by the processors) one or more processes described herein.

According to some embodiments, building controller 720 includes controller coordinator 742. Controller coordinator 742 may be configured to control the timing and flow of data through the other circuitry of building controller 720. For example, Controller coordinator 742 may cause the various modules to execute in a specific order to perform the function of building controller 720. In some embodiments, Controller coordinator 742 may route the information and/or outputs of other modules that are dependent on the information or use the information as an input. Controller 720 may also be configured with control services, including control logic coordinator 750, schedules 752, control state determination 754, control logic 756, object definitions 758, and control logic 760. Controller coordinator 742 may cause computational resources and/or time to be distributed between performing control processes managed by control logic coordinator 750 and other controller processes (e.g., communications, data management, etc.). Controller coordinator 742 may also manage a real-time clock 748 to coordinator various control or operating system processes that run on schedules.

In some embodiments, building controller 720 includes several control processes (e.g., control logic 756 and 760). Control logic modules may contain instructions that include finite state machines (e.g., as shown in FIG. 5B) and instructions to perform the control algorithms that are performed in each state of the finite state machine. For example, instructions for a proportional-integral-derivative (PID) controller may be saved in a control logic module so that when a control process enters an active control mode, the PID controller can adjust the actuator in order to maintain a condition at its setpoint. In some embodiments, device selections, high limit control, etc. are performed while in various states of a finite state machine.

In some embodiments, building controller 720 includes object definitions 758 to improve code reuse across building controllers. Objects definitions may define a set of common attributes or properties that all objects of that type include. For example, a chiller definition may include a chilled water leaving temperature setpoint and measurement, a chilled water entering temperature measurement, and condenser water entering and leaving measurements that may commonly be used across several control algorithms for chiller system control. Object definitions may also include definitions of control logic concepts. A definition of a finite state machine may include storage for the states of the finite state machine. Object definitions may include hierarchical definitions, for example, the states included in the definition of a finite state machine may all have to follow a state definition that includes transitions and control algorithms. Transitions may be further defined by a condition and a next state.

In some embodiments, building controller 720 includes schedules 752 responsible for monitoring a real-time clock (e.g., provided by controller coordinator 742) and causing the start of execution of control logic (e.g., at the beginning of occupancy or building startup) or the transition between various states of the control logic. Schedules may operate based on human schedules (e.g., days, weeks, months, etc.), may operate on periodic schedules (e.g., causing the execution of an algorithm every 15 minutes), any combination of the two, or any other manner in which time may be used to cause the execution of instructions stored in memory 740.

In some embodiments, building controller 720 includes control state determination 754 to cause proper transitions between the states of any control logic. Control state determination may monitor the conditions defined in and/or used by any of the transitions out of the current control state and make a determination of the next state to enter (or if control should remain in the current state). Control state determination 754 may also use schedules 752 to determine if a transition is required based on the current time, day, day of week, etc.

In general, the processes of receiving data from sensors or other control devices, sending data and/or commands to actuators, and performing the calculations required by the control logic may be done in parallel or in series. In parallel-type operation, the operations may be queued as required by controller coordinator 742 for execution and executed asynchronously. For example, a control algorithm may execute using the latest measurement currently stored in the controller for a measurement required to perform control. In series-type operation, controller coordinator 742 may execute sequences in a defined sequence. For example, controller coordinator 742 may determine the order that control algorithms must run, poll sensors for current information related to the information required for the currently executing control algorithm, perform the calculations of the control algorithm, and then send the results to the actuators before moving to the next control logic module. Building controller 720 may be configured to switch between series and parallel operation or run certain operations in series while running others in parallel. Series operations may be considered a prioritized form of communication as the building controller 720 purposely gets the latest sensor values when needed or may maintain the communication token until the operations of a control logic module are complete.

Control logic coordinator 750 causes the execution of various control logic modules (e.g., control logic 756 and 760) according to some embodiments. Control logic may be run based on a schedule and/or periodically (e.g., every 15 minutes). In some embodiments, control logic modules are configured to first run state transition logic (e.g., determine what mode the control logic module should be in for the current execution). This can be performed using control state determination 754 or any other modules or subroutines stored within memory 740. After the mode/state is determined, the control logic may execute for the given mode. In some modes, various actuators are maintained at a constant value. For example, the damper of mode 592 in FIG. 5B may be maintained at a constant value. In some modes, control is more active (e.g., the damper in free cooling mode 594 of FIG. 5B), and the controller may be configured to make frequent adjustments to actuator values based on sensor measurements in order to achieve a specific control goal (e.g., keep a temperature above a low limit, keep a static pressure at a setpoint, etc.). Within a particular mode, several measurements and commands may need to be communicated over network 710 to, for example, IOM 701 in order to complete the control process. These measurements and commands may compete with other traffic on network 710 and cause poor and/or unstable control. For example, in some embodiments, control logic 760 may not perform its function acceptably if the sensor measurements are delayed or the actuator commands are delayed by other network traffic. Pressure control loops, while particularly critical in health care environments, also require control logic that executes consistently at a sub-second period (e.g., every 100 ms) and with the latest available sensor measurements.

In some embodiments, deterministic mode module 744 recognizes when any control logic enters an active control mode and prioritizes traffic associated with the control mode, the control logic, or the building controller as a whole. An active control mode may refer to any mode of a finite state machine wherein a condition of the building environment is being controlled by periodic (e.g., every 100 ms, every 2 s, every 15 s, every minute, etc.) and/or frequent adjustments to an actuator (e.g., damper position, valve opening, fan speed, etc.) in some embodiments. For example, an active control mode may refer to free cooling mode 594 of state machine 591 of FIG. 5B. In some embodiments, deterministic mode module 744 recognizes when any active control calculation is being performed. For example, various control logic modules (e.g., control logic 756 or 760) or portions thereof may be considered active (e.g., require low latency communication). When that particular portion of the code is running, a signal may be sent to the deterministic mode module indicating that the module is currently in an active control mode. In this manner, any control logic may be flagged as active through an indication such as a commonly managed variable, memory location, or register bit. As such, an active control mode may also refer to any portion of the control logic so flagged, potentially indicating a need for low latency communications and/or rapid control according to some embodiments. For example, the active control flag (e.g., memory location or register bit) may be set when free cooling mode 594 of state machine 591 in FIG. 5B is performing calculations (e.g., performing the state transition calculation or performing the PID control calculation for the damper position).

In some embodiments, control logic coordinator 750 can determine the calculations that need to be performed next for proper control. For example, control logic coordinator 750 could inspect the connections between various portions of the control logic to determine a dependency map. Knowing that the output of the current control algorithm is required as an input to another control algorithm (or a portion thereof) may allow determining the dependency map and/or determining the next control algorithm to run. In some embodiments, there are multiple controllers involved in the calculations required to perform a control task, and the next calculation required may be stored and/or executed on another controller. Control logic coordinator 750 may cause the controller that is performing the next calculation to enter an active control mode. For example, by indicating the next calculation to be performed (which may contain a flag indicative of an active control mode) or by directly signaling the need for the next controller to enter the active control mode.

In some embodiments, deterministic mode 744 is active during time periods when any control logic is in an active control mode (as described in any of the above embodiments). Deterministic mode 744 may be configured to cause priority communications between building controller 720 and any of the external devices on the same network (e.g., network 710) when active. Priority communications ensure the lowest latency possible during the active control calculations that are required for smooth control of the building equipment.

In some embodiments, deterministic mode 744 communicates an adjustment to the change-of-values (COVs) of other devices (e.g., other sensors, IOMs, controllers, etc.) on the same network as building controller 720. For example, building controller 720 may cancel a subscription to a COV and create a new subscription to the same value/sensor with different parameters. Building controller 720 may also ask other controllers on the network to make similar or the same adjustments to their COVs that are not part of an active control mode. Adjustments to COVs may increase the minimum COV required before a communication is sent. Adjustments can be specified in fractional form (e.g., multiplying the COV by 1.25) or in absolute terms (e.g., adding 0.5 to the COV). Adjustments can be sent to an individual COV, a group of COVs, or all COVs that are not used by the control logic in an active mode. Increasing the COVs of other sensors or data points has the effect of causing less communication on the network, thus prioritizing communications for values whose COV has not been increased. In some embodiments, building controller 720 is configured to receive requests for changes to its own COV subscriptions and modify those COV subscriptions not required for active control.

In some embodiments, network traffic may be predicted as a function of time and/or adjustments to the COV. Predictions of network traffic may provide information related to the need to prioritize traffic by entering a deterministic communications mode. For example, traffic may be elevated at plant start-up. During this time period, more controllers and/or control algorithms may require entering a deterministic mode to ensure prompt communications of values in a time frame that allows the control algorithms to maintain appropriate (e.g., stable) control of the equipment. For example, during startup, all control loops required to be run on a period of less than 15 seconds may cause the controller to enter a deterministic mode. Predictions of traffic may also be based on adjustments to the COV and the information may be used to determine by what amount COV thresholds must be increased in order to maintain the level of communications below a threshold where control is known to be capable of executing on the network (e.g., less than 500 COVs per minute).

In some embodiments, deterministic mode 744 may add a priority to the data. The priority may be respected by other devices on the network, and they may be configured to transmit and/or process those communications with a higher priority first. For example, on an IP network, deterministic mode 744 may cause all outgoing communications traffic to have an elevated priority added to the IP header of a packet. IOMs or other equipment responding to sensor requests may also be configured to notice the indication of the elevated priority in the packet and send any information back to the requesting controller with elevated priority. IP packet differentiation may allow for several priorities to be indicated. For example, the priority could simply be the period of the control loop (e.g., 1 second loops having higher priority than 5 second loops in turn having higher priority than 30 second loops and so on).

In some embodiments, network 710 is a token passing network wherein only the device with the communication token is allowed to initiate network communications. To prioritize traffic in a token passing network, communications from control algorithms in an active control mode may be sent over the network first, and not until all active control communications are sent are any additional communications (e.g., for display purposes, etc.) sent. Devices on the network may be configured to send only the prioritized communications as long as any device on the network has a prioritized communication. For example, if the token cycles the network with no transmissions being performed, the next cycle of communications may include unprioritized network traffic. In some embodiments, deterministic mode 744 may determine the next time building controller 720 will be required to communicate information on the network (i.e., gather sensor information and/or send out actuator commands). Other equipment on the network may be configured to release the token before completing all potential communications so that building controller 720 receives the token again in time to perform its calculations. In some embodiments, each device on the token passing network (e.g., network 710) transmits a time the device will need to communicate again as well as an expectation of how long its prioritized communications will take. When a device has the token, the device can then perform calculations to determine how much time it can spend on unprioritized communication while still allowing for other devices to meet the requirements of their active control loops. In some embodiments, not all devices will contain the additional logic to perform these calculations. For example, some devices may simply follow a standard sequence and communicate all data. Deterministic mode 744 may predict the communications that will be performed by those other devices (e.g., an average of recent history) and, if necessary, send a command to cause COV subscriptions to those values to be modified so that the amount of data they send decreases. Predictions of the communications of devices following a standard sequence may also be used to calculate the amount of time building controller 720 can spend sending unprioritized communications (e.g., not related to active control). In this way, building controller 720 may ensure that active mode communications are prioritized and meet the timing requirements of the control algorithm.

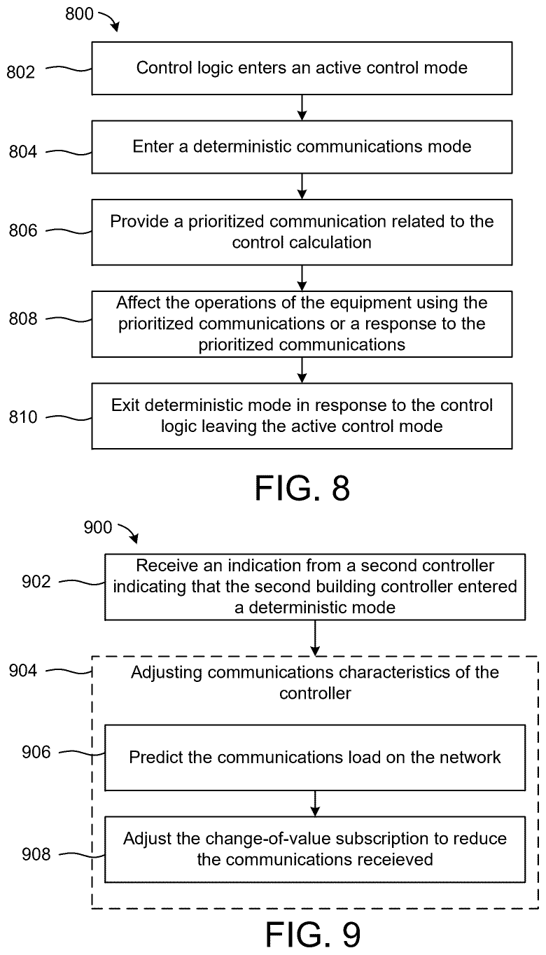

FIGS. 8-12 show flows of operations that relate operations that can be performed in order to enter a deterministic communications mode and/or prioritize communication so that deterministic communication is possible for the control algorithms that require it.

FIG. 8 shows flow of operations 800 for providing prioritized communications in a deterministic communications mode according to some embodiments. Flow of operations 800 may include operation 802 where control logic (e.g., control logic 760) enters an active control mode. Active control modes may be entered for a number of reasons. For example, control logic may contain finite state machines wherein some of the states (e.g., modes) require active control (e.g., periodic adjustments to an actuator in response to feedback) and other states may have actuators fixed at a specific position. During active control deterministic communication (e.g., low latency) may be required for appropriate control of the equipment. In some embodiments, active control modes are entered based on the task the controller is currently performing. For example, an active control mode may be entered, calculations may be performed, and the active control mode exited periodically each time the controller is scheduled to make an adjustment to the actuator and/or receive feedback from a sensor. This process of periodically entering and exiting an active control mode based on the current calculations being performed by the controller may occur within a state of a finite state machine or within a controller or control algorithm that has no finite state machine.

In some embodiments, flow of operations 800 includes entering a deterministic communications mode in operation 804. A deterministic communications mode refers to a state of the controller wherein some communications (e.g., those related to control of equipment) are prioritized over others. Deterministic communications mode may, for example, be used in order to ensure or increase the probability that communications related to control arrive in time for control calculations to use them. In some embodiments, that may require latencies of 100 ms or less for control calculations that happen on a fast period.

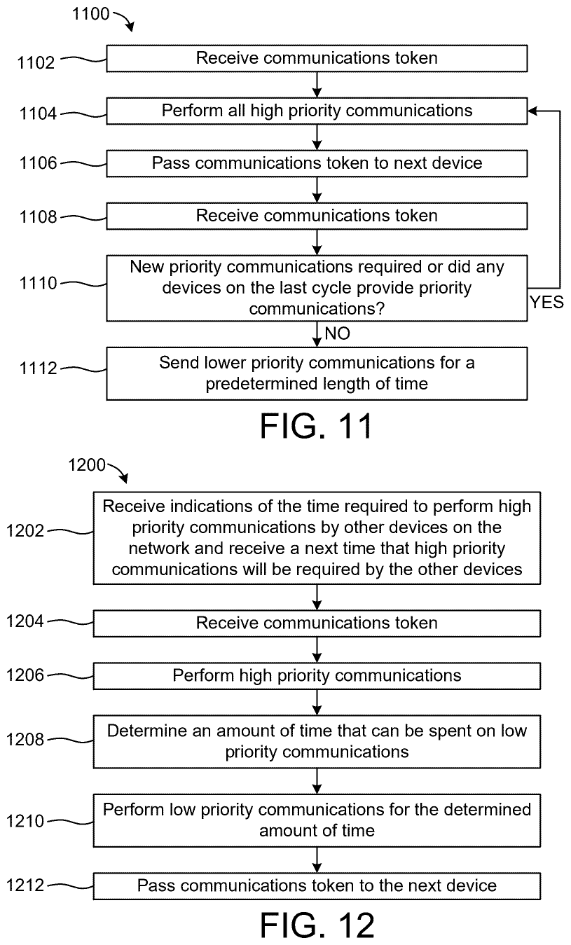

In some embodiments, flow of operations 800 includes providing prioritized communication related to a control calculation in operation 806. A communication related to a control calculation may refer to a request for a sensor value, a communication with a sensor measurement, a command to an actuator, the result of a calculation being sent to another controller for further processing, etc. Prioritization of such communication can be performed using several techniques. The most appropriate approach may depend on the type of network on which the controller is communicating. Various techniques were described previously with reference to FIG. 7 (e.g., deterministic mode 744). For example, a priority can be added to the header of an IP communication and/or controllers can manipulate how they pass the token within a network implementing a token passing protocol. Flows of operations for prioritizing a communication or communications are described in more detail with reference to FIGS. 11 and 12.

In some embodiments, flow of operations 800 includes affecting the operations of the equipment using the prioritized communications. For example, the controller could send prioritized communications to an actuator to affect the operations of equipment, or the controller could send a prioritized request for sensor information that is used to perform a control calculation that is sent to affect the operations of the equipment. In some embodiments, flow of operations 800 includes exiting the deterministic communications mode in response to the control logic leaving the active control mode.

In some embodiments, a building controller is configured to receive an indication from a second controller that the second controller has entered a deterministic communications mode. The building controller may, in response, change properties related to its communication. These operations may be performed to prioritize communications from the second controller that entered the deterministic mode (e.g., to perform operation 806 or a similar operation). FIG. 9 shows flow of operations 900, describing a similar flow for adjusting communication characteristics of the building controller according to some embodiments. In some embodiments, flow of operations 900 includes receiving an indication from a second controller indicating that the second building controller entered a deterministic mode. The deterministic mode may be entered for a variety of reasons related to the control of equipment (e.g., entering an active control state) in operation 902. According to some embodiments, the controller may respond by adjusting its communications characteristics in operation 904. For example, adjusting its communications characteristics may include adjusting a change-of-value (COV) subscription in operation 908. The COV threshold may be increased for certain devices to reduce the amount of network communication thus prioritizing other network communications. In some embodiments, it may be necessary to unsubscribe to a sensor COV and then subscribe to that COV with a larger threshold to perform the adjustment, if modifications to the COV subscription are not allowed.

In some embodiments, the communications load on the network may be predicted to determine by what amount COVs that are not a priority must be increased to ensure prioritized communications reach their destination with low latency. This adjustment amount may be based on factors such as the time of day and/or what other building controllers have already entered into a deterministic mode. For example, often many COV communications are generated at startup. A portion of those communications may be for tracking purposes only, and the COV threshold can be increased to allow priority communications during the startup time period.

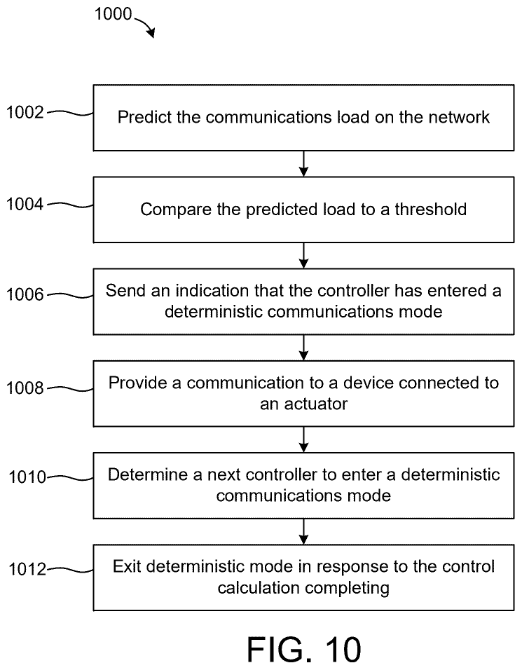

In some embodiments, a deterministic communications mode is entered if network traffic is at or predicted to be at an elevated level. FIG. 10 shows the flow of operations 1000 for entering a deterministic communications mode in response to elevated network traffic, according to some embodiments. Flow 1000 may be performed by a combination of the components of building controller 720 (e.g., controller coordinator 742 and deterministic mode 744) or a similar building controller. Flow 1000 may include predicting the communications load on the network in operation 1002. The predicted load may be compared to a threshold in operation 1004. In some embodiments, the current communications load on the network is compared to a threshold rather than a predicted load. If the load is above the threshold and other conditions for entering deterministic mode are satisfied (e.g., in an active control state), the building controller may enter a deterministic mode. Upon entering a deterministic mode, the building controller may send an indication that the controller has entered the deterministic communications mode in operation 1006. For example, the indication may be provided to other building controllers and/or devices such as IOMs or smart actuators, so that they can allow communications from the building controller to be prioritized.

Flow 1000 includes providing communication to a building device connected to an actuator in operation 1008 according to some embodiments. This allows the controller to perform the function of maintaining control of the building equipment (e.g., to maintain a physical condition at a setpoint). In some embodiments, flow 1000 includes determining a next controller to enter a deterministic communications mode in operation 1010. The flow may include determining the next calculations that need to be performed for proper control. Such operations could be performed, for example, by control logic coordinator 750 described above. Connections between various portions of the control logic could be inspected to determine a dependency map. Knowing that the output of the current control algorithm is required as an input to another control algorithm (or portion thereof), may allow determining the dependency map and/or determining the next control algorithm to run. If the next control algorithm is implemented in another controller or device, it may be signaled in operation 1010. After the control calculation is complete, the building controller or other device executing flow 1000 may exit the deterministic communications mode according to operation 1012. Operations 1010 and 1012 may be of particular use if the building controller enters deterministic communications mode based on the specific calculations that are being performed at the current time.

FIGS. 11 and 12 generally relate to operational flows that can be used to prioritize communications on a network implementing a token passing protocol according to some embodiments. With reference to FIG. 11, flow 1100 is used to provide priority communications by ensuring that all high priority communications are provided before lower priority communications are provided in some embodiments. A communications cycle for a building controller (e.g., building controller 720) may begin by receiving the communications token in operation 1102. The communications token provides that device with the right to initialize communications on the token passing network. In some embodiments, flow 1100 includes performing all high priority communications in operation 1104 (e.g., communications that are related to an active control mode or an active control calculation), and then passing the communications token to the next device on the network in operation 1108. This ensures that other controllers can provide priority communications if they have entered a deterministic communications mode as well.

After some time, the building controller may again receive the communications token in operation 1108. Flow 1100 may include determining if any new high priority communications must be sent in operation 1110. Operation 1110 may also include determining if any other devices performed priority communications on the last cycle through all devices connected to the network. If no high priority communications were performed or are required by the current device, lower priority communications may be performed on this pass and flow may continue to operation 1112. Otherwise, there may still be high priority communications to perform, and flow will continue with operation 1104. In some embodiments, transmission of lower priority communications is limited to an amount of time in operation 1112. This may ensure that all devices have a chance to send some lower priority communication and/or that the token cycles around the equipment fast enough to not delay the next high priority message that must be sent by any device.

With reference to FIG. 12, flow of operations 1200 is used to distribute network traffic among the controllers such that high priority communications are received with low latency in some embodiments. Flow 1200 may be performed by building controller 720 or a similar device in some embodiments. According to some embodiments, operation 1202 of flow 1200 includes receiving communication requirements from other equipment on the network. Information related to communication requirements may include how much time a device will need on the network and/or the next time a device will require the communications token in order to perform the communications required for its upcoming control calculation. Not all devices on the network may follow this process, for those that do not, it may be necessary for the building controller to monitor the amount of time it typically spends performing the calculations and create an estimate of its communications requirements. For example, the estimate may be calculated by averaging previous times spent holding the token. At some point a controller performing flow 1200 may receive the token in operation 1204 and perform its high priority calculations in operation 1206. Once all high priority communications are completed, flow 1200 may continue with determining an amount of time that can be spent on low priority communications in operation 1208.

In some embodiments, determining the amount of time is based on the timing requirements received by the other controllers in step 1202. Based on the order in which the communications token is passed, it may be possible to determine the critical path (e.g., timeline) to follow while ensuring that each device will receive the token in time to perform their required communications. For example, a timeline can be made with each device's time required for high priority communications in order. This timeline can be compared to the time received for the next time a device requires the token. A variable amount of time can be added to the beginning of this timeline, representing the time spent working on lower priority communications, and the variable amount of time may be increased until the time requirements of the devices are no longer met. In some embodiments, margins can be added to each device's time required for high priority communication to account for unexpected communications or an unexpectedly long amount of time spent performing those communications. Margins may also represent time for those devices to also perform low priority communications. In some embodiments, calculations are performed to distribute the margin in some way to ensure that all devices get an amount of time to perform lower priority communications.

In some embodiments, flow 1200 may include performing low priority communications for the determined amount of time in operation 1210, and after the amount of time has expired passing the communications token to the next device in operation 1212.

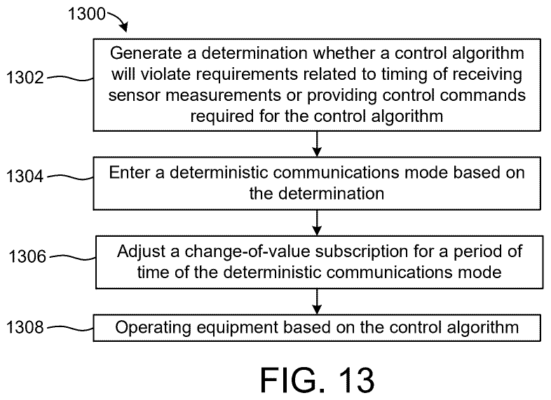

With reference to FIG. 13, flow 1300 of operations is used to provide low latency communications for control, according to some embodiments. Flow 1300 may be performed by building controller 720 or another suitable device. In some embodiments, flow 1300 generates a determination related to whether a control algorithm will violate requirements related to latency in receiving sensor measurements required as inputs to the control algorithm in operation 1302. To generate the determination the network traffic may be predicted or otherwise estimated using historical data related to network traffic for similar times and/or conditions. For example, the historical data related to the amount or latency of network traffic for the same day of the week and time of day may be averaged to form the prediction. If the determination is true, a deterministic state may be entered in operation 1304 to provide priority communications. To provide priority communications, a COV subscription may be modified during the deterministic mode in operation 1304. The COV threshold for unprioritized communications may be increased to lower the level of network traffic and provide lower latency communications for those communications that are a priority (e.g., those used to perform control). In some embodiments, the control algorithm operates the equipment, providing an enhanced level of service because of the prioritized communications in the deterministic mode in operation 1308.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A building controller for providing low latency control, the building controller comprising:
one or more memory devices having instructions stored thereon that, when executed by one or more processors, cause the one or more processors to perform operations comprising:
entering a deterministic communications mode in response to a control algorithm entering an active control state;
providing a prioritized communication related to the control algorithm to a building device; and
affecting operations of equipment using the prioritized communication or a response to the prioritized communication.

2. The building controller of claim 1, wherein the building controller provides communications over at least one of:
a token passing network;
an internet protocol network; or
a network using polled communication.

3. The building controller of claim 1, the operations further comprising causing the control algorithm to enter the active control state based on a schedule.

4. The building controller of claim 1, wherein providing the prioritized communication related to the control algorithm comprises adjusting a change-of-value configuration on a second building device.

5. The building controller of claim 1, wherein the building controller provides communications over a network using a token passing protocol, wherein the operations further comprise keeping a communications token until the control algorithm exits the active control state.

6. The building controller of claim 1, wherein the building controller provides communications over a network using a token passing protocol, wherein the operations further comprise calculating a maximum time a second building controller on the network can hold a communications token given a target latency guarantee.

7. The building controller of claim 1, wherein the building controller provides communications over an internet protocol network, wherein the operations further comprise adding a priority to a data header.

8. The building controller of claim 1, wherein providing the prioritized communication related to the control algorithm comprises polling a value required to execute the control algorithm from the building device.

9. The building controller of claim 1, wherein providing the prioritized communication related to the control algorithm comprises communicating a control output to the building device, wherein the building device is connected to an actuator required to perform a control action.

10. The building controller of claim 1, the operations further comprising causing a second building device to enter the deterministic communications mode.

11. The building controller of claim 10, the operations further comprising determining a next building controller that should enter the deterministic communications mode.

12. A first building controller for providing low latency control, the first building controller comprising:
one or more memory devices having instructions stored thereon that, when executed by one or more processors, cause the one or more processors to perform operations comprising:
entering a deterministic communications mode, the deterministic communications mode providing lower latency communications to or from the building controller;
sending a first indication indicating that the first building controller has entered the deterministic communications mode;
receiving a second indication from a second building controller, the second indication indicating that the second building controller has entered the deterministic communications mode; and
adjusting characteristics related to how the building controller communicates in response to the second indication.

13. The first building controller of claim 12, wherein the first building controller is configured to provide communications over at least one of:
a token passing network;
an internet protocol network; or
a network using polled communication.

14. The first building controller of claim 12, wherein the operations further comprise predicting a communications load on a network, wherein entering the deterministic communications mode is performed in response to the predicted communications load being greater than a threshold.

15. The first building controller of claim 12, wherein the first building controller is configured to provide communications over an internet protocol network, wherein the operations further comprise adding a priority to a data header.

16. The first building controller of claim 12, wherein the operations further comprise communicating a control output to a building device connected to an actuator required to perform a control action.

17. The first building controller of claim 12, wherein the operations further comprise sending a third indication indicating a next building controller to enter the deterministic communications mode.

18. A method for providing low latency control, the method comprising:
generating a determination whether a control algorithm will violate requirements related to timing requirements of receiving sensor measurements or providing control commands required for the control algorithm;
entering a deterministic communications mode based on the determination;
adjusting a change-of-value subscription for a period of time of the deterministic communications mode; and
operating equipment based on the control algorithm.

19. The method of claim 18, further comprising determining a next controller that should enter the deterministic communications mode.

20. The method of claim 18, further comprising communicating a control output to another building device connected to an actuator required to perform a control action.
